(19) United States
(12) Patent Application Publication
(10) Pub. No.: US 2026/0273852 A1
(43) Pub. Date: Sep. 17, 2026

(54) 3D PRINTER ADD-ON FOR ENHANCED 3D OBJECT CREATION

(71) Applicant: Christopher Robert Barry, Williamsville, NY (US)

(72) Inventor: Christopher Robert Barry, Williamsville, NY (US)

(21) Appl. No.: 19/566,568

(22) Filed: Mar. 13, 2026

Related U.S. Application Data
(60) Provisional application No. 63/834,318, filed on Mar. 13, 2025.

(51) Int. Cl. B29C 64/30; B29C 64/209; B33Y 10/00; B33Y 30/00; B33Y 40/00

(52) U.S. Cl. CPC B29C 64/30; B29C 64/209; B33Y 10/00; B33Y 30/00; B33Y 40/00

(57) ABSTRACT

A modular, automated tool-changing system for an additive manufacturing machine is disclosed. The system comprises a print head assembly, a plurality of interchangeable tool holders, a docking system, and an automated tool changer carriage for transporting the tool holders between the docking system and the print head. The print head assembly includes articulating clamp arms that function as integrated, actively-cooled heatsinks, providing both secure mechanical clamping and direct thermal management to a seated tool holder. The tool changer carriage utilizes a multi-function cylindrical cam and a flexible interlocking rack gear to perform the complex movements required to retrieve, transport, and deposit tool holders. A control system non-invasively utilizes the host machine's extruder (‘E’) stepper channel, toggling the signal to drive either the tool changer carriage or the print head's extruder motor, with the system's state determined by the physical position of the print head.

### CROSS REFERENCE TO RELATED APPLICATION

This application claims the benefit of U.S. Provisional Patent Application No. 63/834,318, filed on Mar. 13, 2025 entitled “3D printer add-on for enhanced 3D object creation,” the entire contents of which are incorporated herein by reference.

### FIELD OF THE INVENTION

The present disclosure relates generally to the field of additive manufacturing, and more particularly, to systems, methods, and apparatus for enabling multi-material, multi-color, and multi-tool fabrication using three-dimensional printers.

### BACKGROUND

Three-dimensional (3D) printing, also known as additive manufacturing, has become an increasingly accessible technology for rapid prototyping and manufacturing. One of the most common forms of 3D printing is Fused Deposition Modeling (FDM). In a typical FDM process, a thermoplastic or synthetic rubber feedstock, supplied as a filament from a spool, is fed into a heated extruder. The extruder melts the filament and deposits the molten material in precise layers onto a build platform, where it cools and solidifies. An object is built up layer-by-layer according to a digital model.

The conventional configuration of FDM printers has traditionally limited them to printing with a single filament at a time. Consequently, objects produced are typically of a single material and color. While it is technically possible to pause a print, manually retract the current filament, load a new one, and resume printing, this process is impractical, time-consuming, and prone to error, making it unsuitable for complex objects requiring frequent material changes.

To address this limitation, various technologies have been developed to enable multi-material or multi-color FDM printing. However, these existing solutions introduce their own significant problems and limitations, rendering them sub-optimal.

One approach is the use of multiple extruders. In some variants, several complete extruder assemblies are mounted on the same print gantry, each dedicated to a specific material. In others, known as tool-changing systems, only one extruder is active at a time, while inactive extruders are parked at a docking station. A related variant, the independent dual extruder (IDEX) system, uses two extruders on the same gantry that can move independently. While these systems avoid the need to purge material, they suffer from other drawbacks. Calibrating the precise X, Y, and Z-axis offsets for multiple nozzles is difficult and critical for print quality. Inactive but heated nozzles are prone to oozing material, which can be dragged across the printed object, causing defects. Furthermore, the physical size and weight of multiple extruder assemblies limit the total number of materials that can be incorporated and can negatively impact print speed and acceleration. These systems are also expensive and complex to implement as add-ons to existing printers.

Another common approach is the use of an external filament spool selector. These devices manage multiple filament spools and selectively feed one filament at a time through a long guide tube to a single extruder and hotend. When a material change is required, the current filament is retracted from the tube, and a new filament is loaded. A primary disadvantage of this method is the substantial waste of time and material. Before the new material can be printed, the remnants of the previous material must be completely purged from the shared nozzle. This purging process, often requiring a “purge tower” to be printed alongside the object, significantly increases print time and consumes a large amount of filament, particularly when changing between high-contrast colors like black and white. Additionally, these systems are often unreliable for pushing soft, flexible filaments through long tubes, as the filament can buckle and jam.

A third approach involves segmented multi-filament systems. These devices take multiple input filaments, cut them into small, calculated lengths, and splice them together serially into a single composite strand. This strand is then fed to the printer's hotend. While this method can reduce purging waste, it introduces significant complexity and has its own set of limitations. The transitions between materials are often imprecise, resulting in a “fade” effect rather than a crisp delineation. The process is unsuitable for soft or rubbery materials and typically requires all materials to have similar melting temperatures and to be used with the same nozzle size. The mechanical complexity of cutting and splicing many small filament pieces makes these systems prone to jamming and failure.

Each of these existing technologies for multi-material printing suffers from a combination of drawbacks, including material waste, slow operational speed, material incompatibility, high cost, and mechanical complexity. Therefore, a need exists for an improved system that can efficiently and reliably perform multi-material and multi-color 3D printing while overcoming these limitations.

### SUMMARY OF THE INVENTION

The present disclosure is directed to a modular, automated tool-changing system for additive manufacturing machines, such as Fused Deposition Modeling (FDM) 3D printers. Conventional FDM printers are typically limited to using a single material or color per print job. Existing solutions for multi-material printing suffer from significant drawbacks, including extreme material waste and time loss from purging filaments, nozzle-oozing and part contamination, mechanical complexity, high cost, and an inability to reliably use certain classes of materials, such as soft or flexible filaments. The disclosed invention overcomes these deficiencies by providing a system and method for rapid, waste-free, and versatile tool changing.

In accordance with one aspect of the present disclosure, a modular tool-changing and extruder system is provided as a replacement for a standard extruder on a 3D printer. The system comprises a print head assembly, a plurality of interchangeable tool holders, a docking system for storing the tool holders, and an automated tool changer carriage configured to transport the tool holders between the print head and the docking system. This architecture separates the active, powered components, which are consolidated in the print head, from the passive, inexpensive tool holders, enabling efficient and scalable multi-tool functionality. In further embodiments, the articulating nature of the print head's clamping mechanism allows the system to accommodate tool holders of various sizes, thereby scaling its capabilities for more demanding industrial applications. In further embodiments, the system may be integrally incorporated as part of a complete additive manufacturing machine.

To achieve broad applicability as a non-invasive add-on, the system is adapted for various printer architectures through the use of form-factor specific mounting components. While the core operational components of the print head, tool holders, and tool changer carriage remain consistent, the mounting brackets that affix the docking system to a host printer's frame are designed to be specific to a printer's type, including but not limited to Cartesian XZ-gantry, CoreXY, or Delta style printers. This maintains the universal functionality of the tool-changing system while allowing for its installation across a wide range of commercially available three-dimensional printers.

In some embodiments, the print head assembly includes a main body, a clamping mechanism, and an extrusion drive mechanism. The clamping mechanism comprises a set of articulating clamp arms driven by at least one dual-threaded clamping screw, configured to securely engage a tool holder within a conical alignment receptacle for operation and release it for storage. The extrusion drive mechanism, which includes an extruder stepper motor and interlocking extruder drive wheels, is configured to engage with and provide motive force to drive a filament feedstock. The print head also includes a hotend assembly configured to thermally engage a nozzle on a filament-based tool holder.

According to a preferred embodiment of the invention, a modular tool-changing system for a three-dimensional printer comprises a print head assembly configured to receive an interchangeable tool holder, the print head assembly comprising a pair of articulating clamp arms configured to secure the tool holder. The articulating clamp arms comprise integrated heatsinks configured to make direct thermal contact with the tool holder when clamped. This consolidation of mechanical clamping and thermal management into the clamp arms enables the use of passive, lightweight, and inexpensive tool holders by obviating the need for separate thermal management components on each tool holder. This efficiency maximizes the number of tools that can be docked and made immediately available in a given space. Furthermore, the large, centralized heatsink capacity of the clamping arms enables the use of thermal tools at much higher temperatures, expanding the range of usable materials to include engineering-grade plastics, such as PETG or PEEK, and enabling processes like high-temperature soldering.

In another aspect of the disclosure, the system is designed to support high-temperature printing operations, with certain embodiments capable of reaching nozzle temperatures up to 500° C. This capability is achieved through the synergistic design of the print head assembly, which integrates large, actively cooled heatsinks into its articulating clamp arms. When a tool holder is clamped, these heatsinks make firm contact with the tool's aluminum clamping section, while the tool's own heat-break section provides thermal isolation. This robust, centralized thermal management enables the reliable use of high-performance, engineering-grade polymers such as PEEK, PEKK, and Ultem. Furthermore, this architecture facilitates rapid thermal cycling because the powerful hotend assembly does not have to heat a large, integrated heatsink on the tool itself, a newly loaded tool can reach operating temperature swiftly. Conversely, a hot tool cools quickly once unclamped and physically separated from the print head's heatsinks. This efficiency minimizes tool changing time, reduces the risk of material oozing from inactive nozzles, and significantly expands the operational window of the host 3D printer.

In another aspect of the disclosure, the tool holder is a standardized, passive, and modular component designed to house a specific tool or feedstock. A tool holder for filament-based feedstock, for example, comprises a main tool holder body, a conical alignment and indexing mounting feature for precise alignment within the print head, an aluminum clamping section with a square profile, and extruder wheel access slots for engagement by the print head's drive wheels. Further embodiments of the tool holder are contemplated to extend the system's capabilities beyond traditional extrusion, accommodating tool holders configured for dispensing alternative feedstocks such as liquids, gels, or powders; incorporating subtractive manufacturing tools such as mills, drills, sanders, and circular saws; utilizing energy-based process tools including lasers for cutting or curing, hot melting tips, and soldering tools; and employing components for automated assembly and sensing, such as pick-and-place grippers and various sensors for probing or inspection. As the add-on system is modular in nature, it can be fitted with these and other specialized tools and their necessary components, transforming the host 3D printer into a versatile, multi-process fabrication device.

According to another aspect of the disclosure, the automated tool transfers are performed by a tool changer carriage (TCC) assembly operating in conjunction with a docking system. The docking system comprises a docking beam with a plurality of tool docks for storing the tool holders. The TCC assembly is configured to travel along the docking beam and comprises a rotary carousel and a flexible interlocking rack gear. The flexible interlocking rack gear, or “Flex-Rack”, comprises two flexible, toothed halves that are driven from the rotary carousel to interlock and form a single, rigid, linear pushrod. Positioned at the distal end of the Flex-Rack is an end-effector, such as a gripper assembly, configured to grasp a tool holder. During a tool change, the TCC mechanically couples to the print head, actuates the Flex-Rack and rotary carousel to retrieve a tool holder from either the print head or a tool dock, and transports it between the two.

In yet another aspect, a control system is provided to orchestrate the operations of the entire system, allowing it to function as a seamless, non-invasive add-on component. The host 3D printer's core firmware remains unmodified and is effectively unaware of the tool-changing system's presence. All tool-changing operations are driven by standard GCODE commands, inserted into the print file by slicer software and/or GCODE post-processing software. The control system includes an interface board that intercepts the standard extruder motor command (the ‘E’ signal). A mechanical engagement at a predefined position physically trips a switch, toggling the ‘E’ output between motors: the print head's extrusion drive motor, a clamping motor, or a tool change motor, based on the current state of the tool-change cycle.

In an embodiment, the control system utilizes the host printer's standard extruder motor channel (the ‘E’ channel) as the single source for motor control signals. This specific channel is utilized because it is inherently “positionless” within the machine's coordinate system. Unlike the X, Y, and Z axes, which must maintain a persistent and accurate awareness of their absolute position in space, the ‘E’ axis has no concept of spatial coordinates. Its movements are purely relative to its current state, which is effectively reset to zero before each new GCODE command is executed. This unique characteristic allows a toggle switch to redirect the host system controller's ‘E’ channel signal, switching it between the Tool Change Stepper Motor and the onboard Extruder Stepper Motor, without any risk of disrupting or corrupting the host printer's critical XYZ positional tracking. This enables the entire complex tool-changing and extrusion process to be driven by standard GCODE commands in a seamless and non-invasive manner.

A method for creating a three-dimensional object using multiple tools is also disclosed. The method includes providing the modular tool-changing system, retrieving a first tool holder from a storage dock and loading it into the print head, operating the tool within the first tool holder to perform a first step in the object's creation, storing the first tool holder back in its dock, retrieving and loading a second tool holder, and operating the tool within the second tool holder to perform a subsequent step. This process is repeated as needed, allowing for the creation of complex, multi-material, and multi-part assemblies in a single, continuous, and efficient object creation process.

In another aspect of the disclosure, a tool holder for filament feedstock is a standardized, passive, and modular component. Such a tool holder comprises a main tool holder body, a conical alignment and indexing mounting feature for precise mating with the print head, an aluminum clamping section presenting a profile for secure clamping, and extruder wheel access slots for engagement by the print head's drive wheels. The lower portion of the filament tool holder further comprises an aluminum nozzle chuck which secures a replaceable nozzle assembly, the nozzle assembly itself comprising a heat-break section, a hot end of nozzle, and a nozzle tip. This architecture provides a fully standardized, interchangeable, and inexpensive unit for filament-based fabrication.

In further embodiments, the system's capabilities are extended beyond traditional extrusion by accommodating tool holders configured for a wide variety of functions. These may include, but are not limited to, subtractive tools such as drills or mills; pick-and-place grippers utilizing vacuum; sensors such as limit-switch type bed leveling probes; and applicators for adhesives or paints. The modular nature of the tool holder allows the system to be fitted with these and other specialized tools, transforming the host 3D printer into a versatile, multi-process fabrication device.

According to another aspect, the docking system comprises an elongated docking beam mounted parallel to the host printer's X-axis gantry. A plurality of tool docks are removably mounted along the docking beam to receive and store the tool holders. Each tool dock features a conical receptacle that is geometrically identical to the conical alignment and indexing receptacle on the print head assembly. This shared mounting geometry is a key design feature that ensures a tool holder is seated with the same precise and repeatable positioning whether stored in the dock or loaded for operation in the print head, providing consistent alignment throughout the system.

In yet another aspect, the automated tool transfers are performed by an innovative tool changer carriage (TCC) assembly. The TCC's motion is orchestrated by a multi-function cylindrical cam and a coaxially mounted rotary carousel. Housed within the rotary carousel is a flexible interlocking rack gear, which comprises two flexible, toothed halves that can separate to coil into a compact storage space and subsequently interlock to form a rigid, linear pushrod. This pushrod extends a gripper to engage and transport a tool holder. This unique mechanism translates a single rotational input from a motor into the complex sequence of vertical, rotational, and horizontal movements required for tool changes.

In another key aspect, the system's control is orchestrated by a tool changing transmission that mechanically multiplexes the rotational output of a single tool change stepper motor to perform two distinct functions. The state of the transmission is determined by the physical position of the print head assembly. In a default state, the transmission directs the motor's output to the TCC's drive system to perform tool transport. To actuate the clamping mechanism, the print head moves to a predefined position to physically engage the transmission, which reconfigures an internal clutch to redirect the motor's output to the print head's clamping screw. This architecture enables the entire complex tool-change and clamping cycle to be driven by standard GCODE commands intended for a single extruder motor, allowing the system to function as a non-invasive add-on component.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The present invention and the manner in which it may be practiced is further illustrated with reference to the accompanying drawings wherein:

FIG. 1 is a front-left perspective view of an embodiment of the modular tool-changing system installed on a host 3D printer;

FIG. 2 is a top plan view of the embodiment of FIG. 1;

FIG. 3 is a front elevation view of the embodiment of FIG. 1;

FIG. 4 is a right side elevation view of the embodiment of FIG. 1;

FIG. 5 is a perspective view of a host 3D printer, shown for environmental context;

FIG. 6 is a perspective view of the modular tool-changing system of FIG. 1, shown in isolation for clarity;

FIG. 7 is an exploded perspective view of the modular tool-changing system of FIG. 6;

FIG. 8 is a front perspective view of an embodiment of a print head assembly;

FIG. 9 is a cross-sectional view of the Print Head Assembly, taken along line 9-9 of FIG. 8;

FIG. 10 is a cross-sectional view of the Print Head Assembly 110, taken along line 10-10 of FIG. 8;

FIG. 11A is a perspective view of the internal mechanism of the print head assembly, showing a print head assembly in an open and unclamped state;

FIG. 11B is a perspective view of the internal mechanism of FIG. 11A, showing the print head assembly in a closed and clamped state;

FIG. 11C is a rear perspective view of the articulating gear-drive mechanism of the print head assembly in an open state;

FIG. 11D is a rear perspective view of the articulating gear-drive mechanism of FIG. 11C in a closed state;

FIG. 12 is a perspective view of an embodiment of a filament-based tool holder;

FIG. 13 is an exploded perspective view of the tool holder of FIG. 12;

FIG. 14 is a perspective view of the print head assembly with a tool holder installed in an unclamped state, indicating a section line for FIG. 15;

FIG. 15 is a perspective view identical to FIG. 14, showing specific components in section, and introducing a detail callout magnifying the interface between the tool holder and the print head assembly;

FIG. 16 is a magnified, cross-sectional detail view of the interface shown in the callout of FIG. 15;

FIG. 17 is a perspective view of an alternative embodiment of a tool holder, specifically a limit-switch type bed leveling probe tool;

FIG. 18 is a perspective view of an alternative embodiment of a tool holder, specifically a flexdrive driven drill-mill tool;

FIG. 19 is a perspective view of an alternative embodiment of a tool holder, specifically a vacuum type pick-and-place tool;

FIG. 20 is a perspective view of an embodiment of the tool changer carriage (TCC) assembly;

FIG. 21 is a perspective view of the TCC assembly of FIG. 20, with the rotary carousel cover removed to illustrate internal components;

FIG. 22 is a cross-sectional view of the TCC assembly taken along line 22-22 of FIG. 20;

FIG. 23 is a cross-sectional perspective view of the TCC assembly taken along line 23-23 of FIG. 20;

FIG. 24A is a cross-sectional view of the empty rotary carousel housing taken along line 24a-24a of FIG. 21;

FIG. 24B is an isolated cross-sectional view of the internal rack and pinion mechanism in a retracted state housing taken along line 24a-24a of FIG. 21;

FIG. 24C is a perspective cross-sectional view of the gripper fully extended and engaged with a tool holder housing taken along line 24a-24a of FIG. 21;

FIG. 25 is an isolated perspective view of the gripper assembly;

FIG. 26 is an exploded perspective view of the gripper assembly of FIG. 25;

FIG. 27 is a top-down view of the system in an initial state, aligned to retrieve a tool holder from a tool dock;

FIG. 28 is a perspective view showing the TCC gripper extending to grasp a docked tool holder;

FIG. 29 is a perspective view showing the TCC lifting the grasped tool holder from its dock;

FIG. 30 is a perspective view showing the TCC retracting the tool holder into the rotary carousel;

FIG. 31 is a perspective view showing the TCC rotating 180 degrees to face the print head;

FIG. 32 is a perspective view showing the TCC lowering the tool holder to the extension height for insertion;

FIG. 33 is a perspective view showing the TCC extending the tool holder into the print head assembly;

FIG. 34 is a perspective view showing the TCC lowering and fully seating the tool holder within the print head;

FIG. 35 is a perspective view showing the TCC gripper retracting from the seated tool holder;

FIG. 36 is a top-down view of the system in a post-load state, with the print head engaged with the tool changing transmission, ready for clamping;

FIG. 37 is a top-down view showing the clamping of the tool holder and the simultaneous mechanical disconnection of the TCC from the print head;

FIG. 38 is a perspective view showing the print head operating independently after the TCC has been disconnected and parked;

FIG. 39 is a front elevation view of the tool docking system assembly;

FIG. 40 is a rear elevation view of the tool docking system assembly;

FIG. 41 is a perspective view of an individual tool dock;

FIG. 42 is a cross-sectional view taken along line 42-42 of FIG. 39, showing a tool holder aligned with a tool dock;

FIG. 43 is a cross-sectional view taken along line 43-43 of FIG. 40, showing a tool holder fully seated in a tool dock;

FIG. 44 is a perspective view of the tool changing transmission in its default, engaged state;

FIG. 45 is a cross-sectional view of the transmission taken along line 45-45 of FIG. 44;

FIG. 46 is a perspective view of the tool changing transmission in its actuated, disengaged state;

FIG. 47 is a cross-sectional view of the transmission taken along line 47-47 of FIG. 46; and

FIG. 48 is a flowchart diagram illustrating an exemplary sequence of operations for the automated tool-changing process.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of the disclosed subject matter as required by 35 U.S.C. § 112.

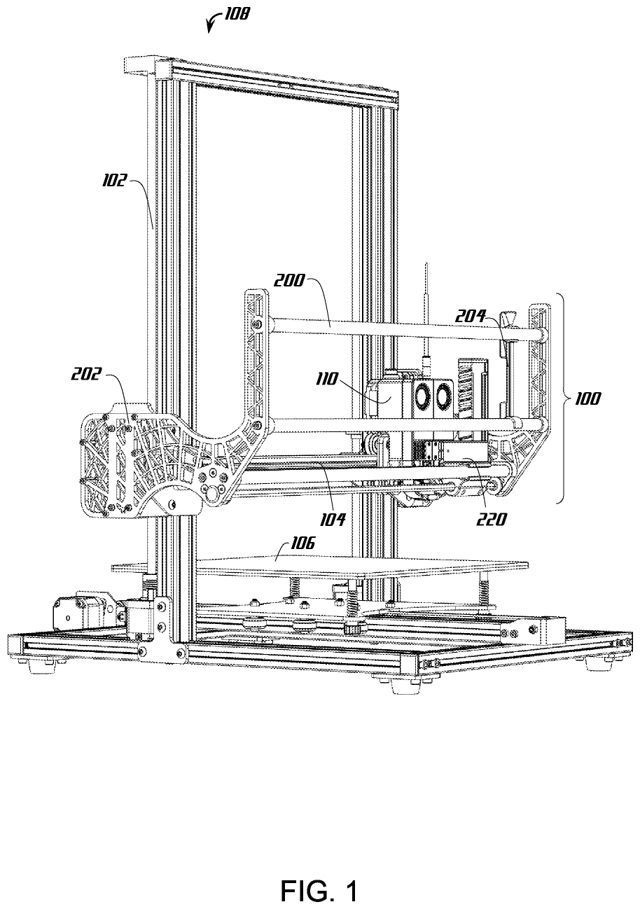

Referring now to the drawings, FIG. 1 illustrates a front-left perspective view of an embodiment of the modular tool-changing system 100. The system 100 is shown installed as an add-on component on a conventional host 3D printer 108. The host 3D printer 108 is depicted as a Cartesian-style Fused Deposition Modeling (FDM) printer, which includes a gantry frame 102, a build platform 106, and an X-axis gantry 104. The modular tool-changing system 100, encompassed by the bracket in the figure, is shown mounted to the host printer's 108 X-axis gantry 104 and gantry frame, replacing the printer's original extruder. This overview illustrates the spatial relationship between the add-on system 100 and the host printer 108 in an operational environment.

The system 100 comprises a Print Head assembly 110 and a Tool Changer Carriage (TCC) assembly 220. The Print Head 110 is mounted to the standard carriage of the X-axis gantry 104, replacing the printer's original extruder. The system 100 further includes a Docking Beam 200, which is mounted to the gantry frame 102 via form-factor specific Docking Beam Mounts 202). This allows the core system to be adapted to a variety of host printer architectures. An exemplary Tool Dock 204 is shown affixed to the Docking Beam 200, illustrating the location where one of a plurality of tool holders would be stored.

The modular tool-changing system 100 is conceived as a non-invasive, bolt-on enhancement for a wide variety of existing FDM printers. The system 100 is designed such that the host 3D printer 108 requires no modification to its internal firmware or control logic. To achieve broad compatibility, the primary mounting components, such as the Docking Beam Mounts 202, are designed to be form-factor specific. While the embodiment shown is adapted for a Cartesian XZ-gantry printer, it is understood that alternative mounting brackets can be implemented to install the system 100 on other printer architectures, including but not limited to CoreXY, Delta, or other Cartesian arrangements, without altering the core components and operational principles of the tool-changing system itself.

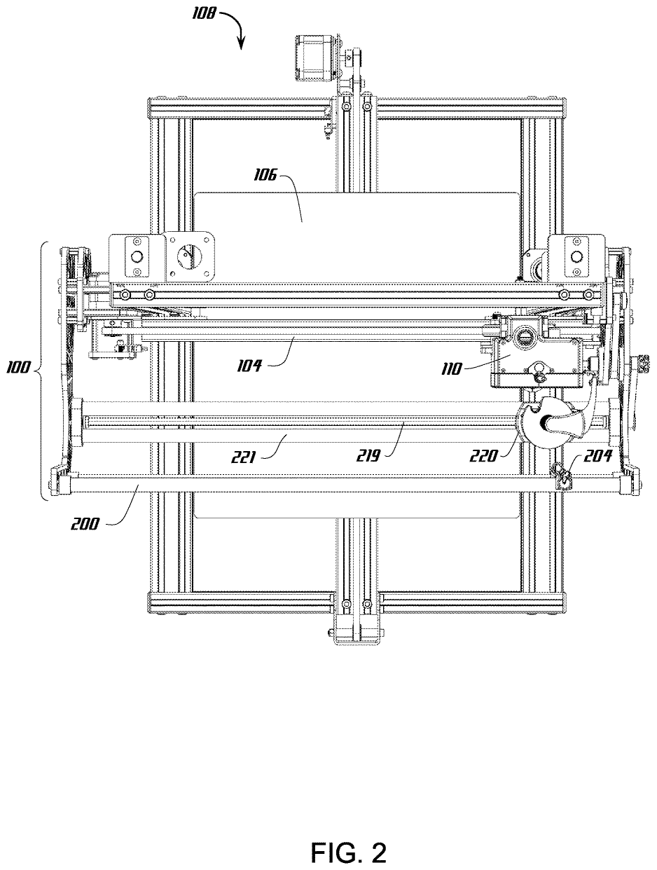

FIG. 2 is a top plan view of the modular tool-changing system 100 installed on the host 3D printer 108. This view highlights the parallel arrangement between the X-axis gantry 104 and the Docking Beam 200. The Print Head (PH) assembly 110 is shown mounted on the X-axis gantry 104. Positioned parallel to the X-axis gantry 104 is the Docking Beam 200, which provides the Tool Changer Carriage Ways 221. Traveling along these ways 221 is the Tool Changer Carriage (TCC) 220, which is driven by the Tool Changer Carriage Drive Shaft 219. An exemplary Tool Dock 204 is also shown affixed to the Docking Beam 200. A fixed offset distance in the Y-direction is maintained between the path of the Print Head 110 and the Docking Beam 200, a critical relationship for ensuring precise alignment during tool transfer operations.

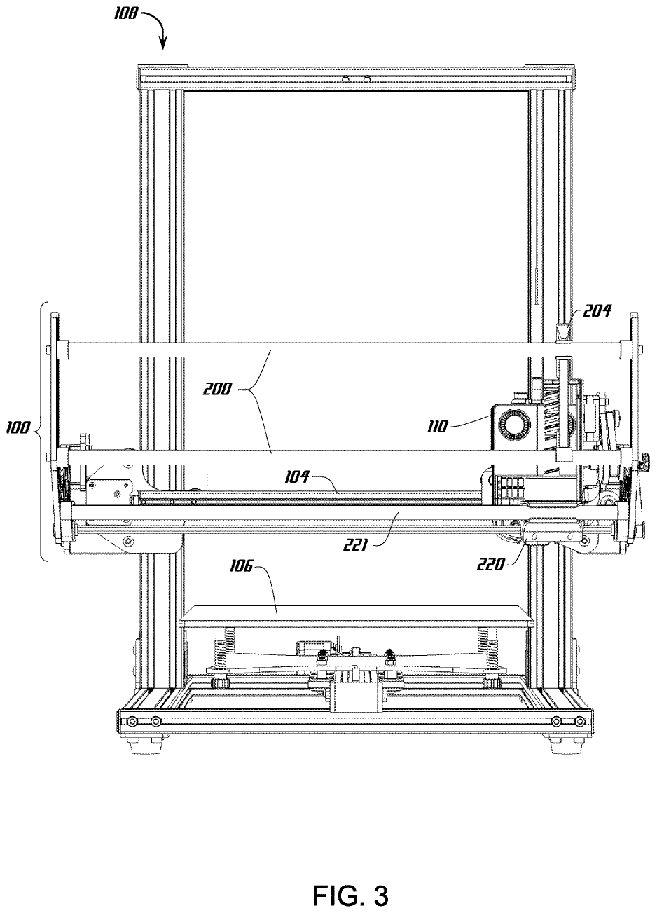

FIG. 3 provides a front elevation view of the modular tool-changing system 100 installed on the host 3D printer 108. This view further illustrates the horizontal and parallel orientation of the Docking Beam 200 relative to the X-axis gantry 104. The Print Head 110 and the Tool Changer Carriage (TCC) 220 are shown positioned together at a maximum X-axis position on the X-axis gantry 104, a configuration indicative of an active tool change operation. An exemplary Tool Dock 204 is shown mounted on the Docking Beam 200, representing a storage location for a tool holder 150. The build platform 106 is positioned below the system 100.

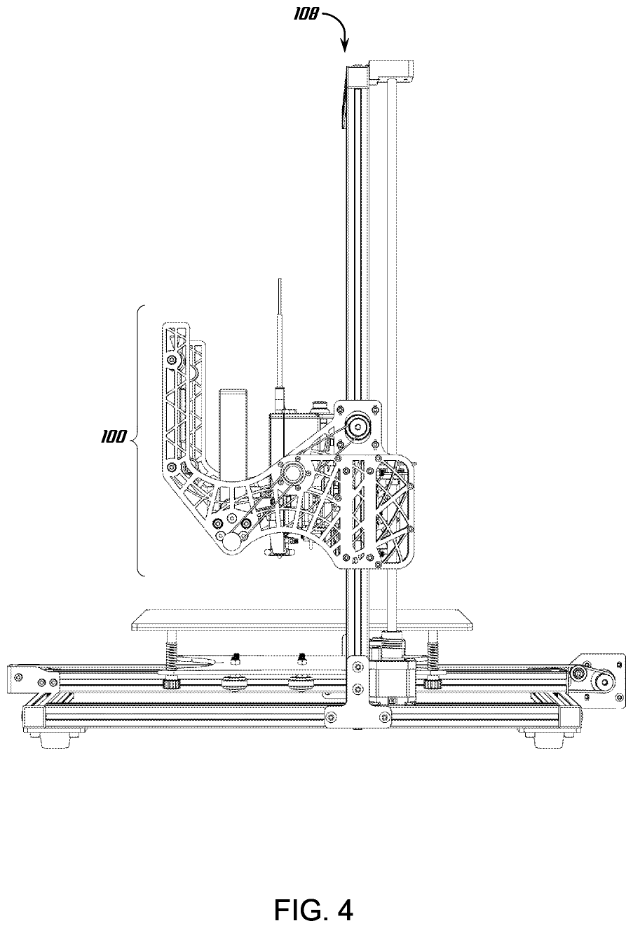

FIG. 4 is a side elevation view of the system 100 installed on the host 3D printer 108, illustrating the profiles of the Print Head 110 and the Tool Changer Carriage 220. This view shows their parallel mounting configuration and their vertical positioning above the build platform 106 of the host 3D printer 108. This perspective is particularly useful for understanding the system's 100 implementation on an XZ-gantry style printer, where the entire X-axis gantry assembly (104, visible in FIG. 3) rises and falls along the Z-axis. Since the system 100 is mounted directly to this assembly, the system 100 moves in unison with it, thereby enabling access to any layer of an object and providing operational coverage across the full vertical build height of the host printer 108.

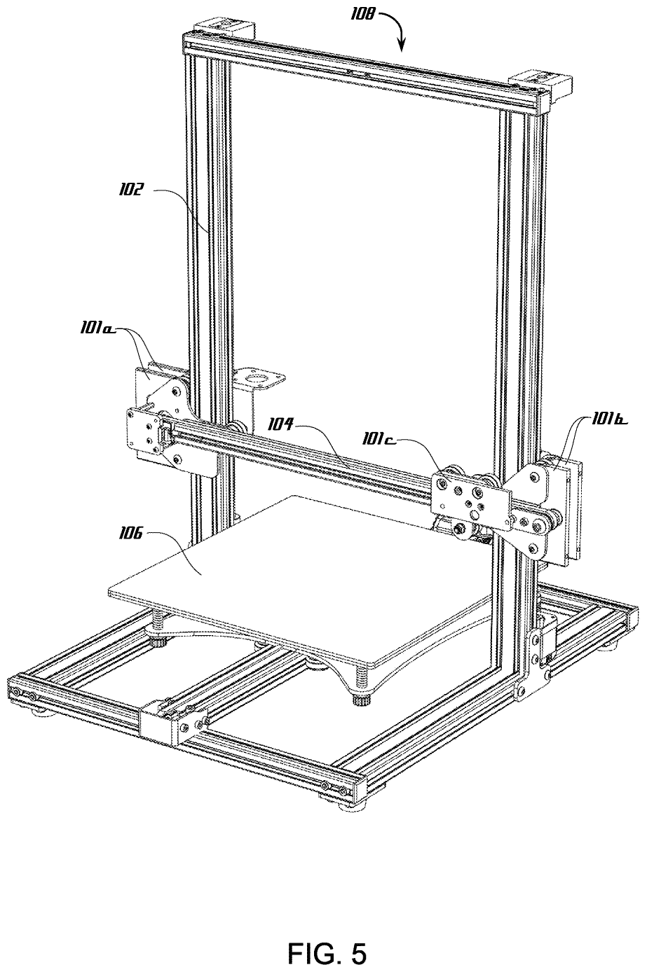

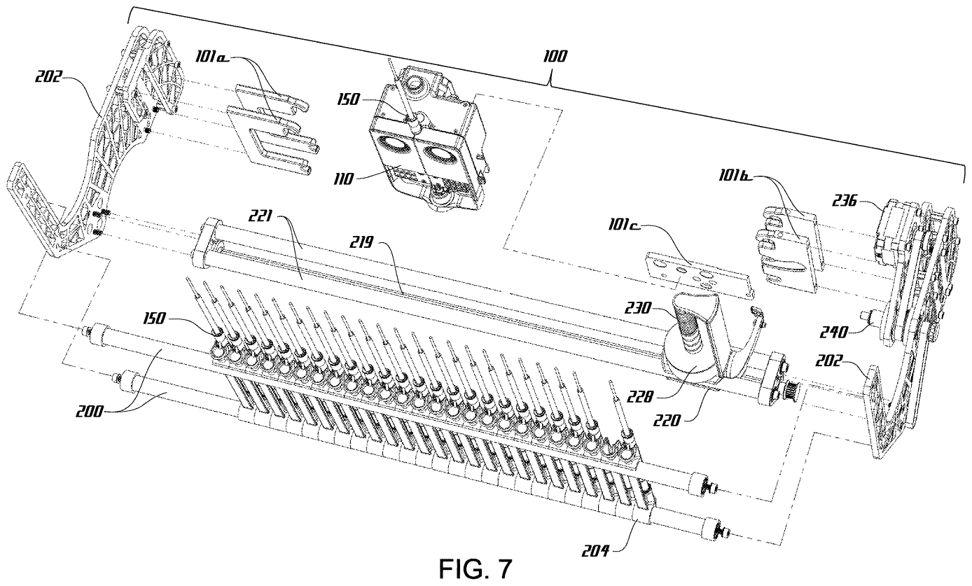

FIG. 5 is a perspective view of a conventional host 3D printer 108, shown for environmental context to illustrate where embodiments of the modular tool-changing system (100, not shown) may be installed. The host 3D printer 108 includes a gantry frame 102, an X-axis gantry 104 configured for horizontal movement, and a build platform 106. In a typical configuration for this printer style, the X-axis gantry 104 moves vertically in the Z-direction, an extruder (not shown, as it is replaced by the invention) moves horizontally along the gantry 104 in the X-direction, and the build platform 106 moves in the Y-direction. This view highlights the printer-specific interface mounts 101a, 101b, and 101c. These mounts are unique to each 3D printer model, as they are designed to conform to the specific geometry, dimensions, and pre-existing mounting points of a given gantry frame 102 or its equivalents. As further illustrated in the exploded view of FIG. 7, the system's 100 own Docking Beam Mounts 202 are configured to interface with these unique mounts 101a-c, allowing the core components of the invention to be securely affixed to a wide variety of host printers without altering their fundamental operational principles.

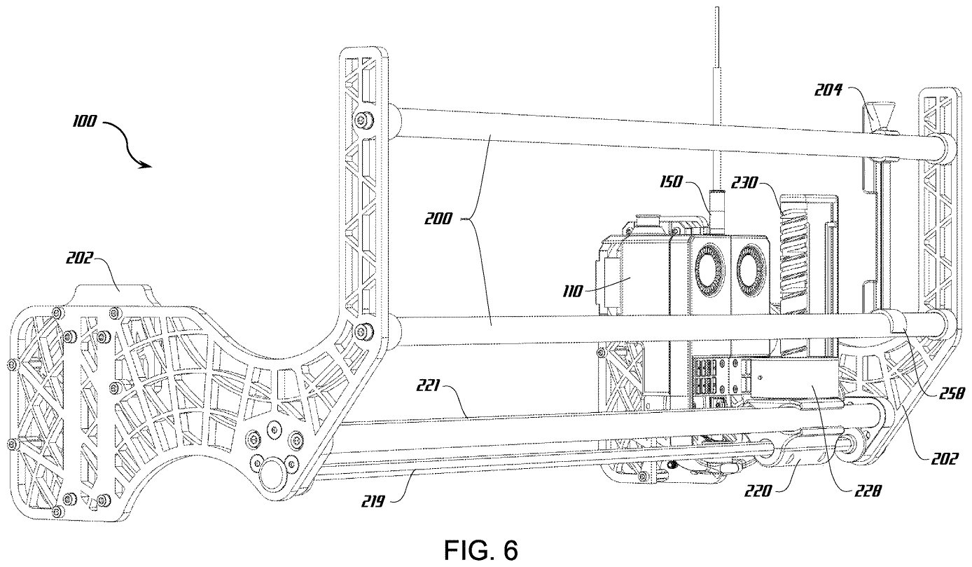

FIG. 6 is a perspective view of the modular tool-changing system 100, shown in isolation and detached from the host 3D printer for improved clarity. This view provides a clear illustration of the core components of the invention and their spatial interrelation, independent of the host machine's frame. The system 100 is shown with its primary structural backbone, the Docking Beam 200, which is supported by Docking Beam Mounts 202. Mounted along the front face of the Docking Beam 200 is an exemplary Tool Dock 204. The Tool Dock 204 is removably mounted via at least one fastener 258 which allows for the modular placement of multiple docks. In various embodiments, such fasteners 258 may comprise, for example, clamps, clips, screws, bolts, latches, or related fasteners. In preferred embodiments, the at least one fastener 258 is integrally molded to the Tool Dock 204.

This arrangement demonstrates the system's 100 capacity to store a library of various tools or materials, though for clarity only one dock 204 is shown in this depicted embodiment. Positioned in front of this passive storage assembly are the active components of the system: the Print Head assembly 110 and the Tool Changer Carriage (TCC) assembly 220. The TCC 220 includes the Rotary Carousel 228 and Multi-function Cylindrical Cam 230, and the TCC 220 travels along the Tool Changer Carriage Ways 221. In this view, a Tool Holder 150 is shown loaded within the Print Head assembly 110. By removing the visual clutter of the host printer's frame, this view highlights the self-contained nature of the modular system 100 and the fundamental relationship between its active operational components (110, 220) and its passive storage components (200, 204, 150)

FIG. 7 is an exploded perspective view illustrating the main sub-assemblies of the modular tool-changing system 100. This view builds upon the assembled system of FIG. 6, depicting a more fully populated embodiment to illustrate the system's scalable capacity. The main sub-assemblies are shown separated to clarify their individual structures.

The passive storage and mounting components include the elongated Docking Beam 200, a plurality of Tool Docks 204, and a series of inactive Tool Holders 150. The system 100 is configured to be attached to a host printer's frame (not shown) via the form-factor specific Docking Beam Mounts 202 with the Docking Beam Mounts 202 removably fitted over printer-specific interface mounts 101a, 101b, 101c. In an embodiment, Docking Beam Mounts 202 may be sized and shaped to mount to any printer-specific interface mounts. A plurality of Tool Docks 204 are shown mounted onto the Docking Beam 200. Each Tool Dock 204 is designed to receive and store a corresponding Tool Holder 150. A series of inactive Tool Holders 150 are depicted, each with an associated Feedstock Delivery Tube 174 within.

Also shown separated are the active operational components, which include the Print Head assembly 110 and the Tool Changer Carriage (TCC) assembly 220. The TCC 220 houses key components of the tool-handling mechanisms, including the Multi-function Cylindrical Cam 230 and Rotary Carousel 228. In an embodiment, the Rotary Carousel 228 moves vertically up and down on the Cylindrical Cam 230. The Print Head Assembly 110 is depicted as a distinct unit, ready to receive a Tool Holder 150 from the TCC 220. This exploded view clarifies how the TCC 220 is positioned to travel along the Tool Changer Carriage Ways 221 and how the Print Head 110 is positioned to receive a Tool Holder 150 from the TCC 220.

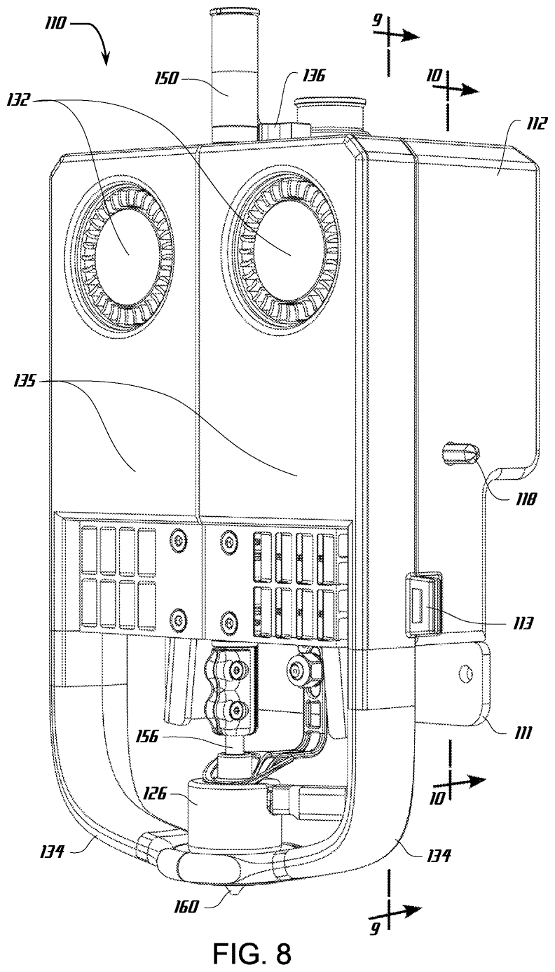

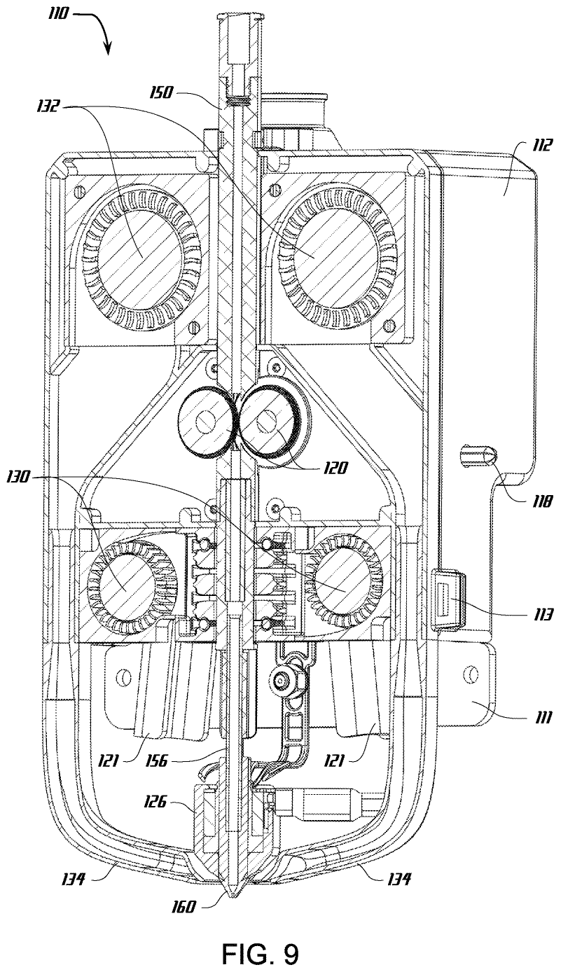

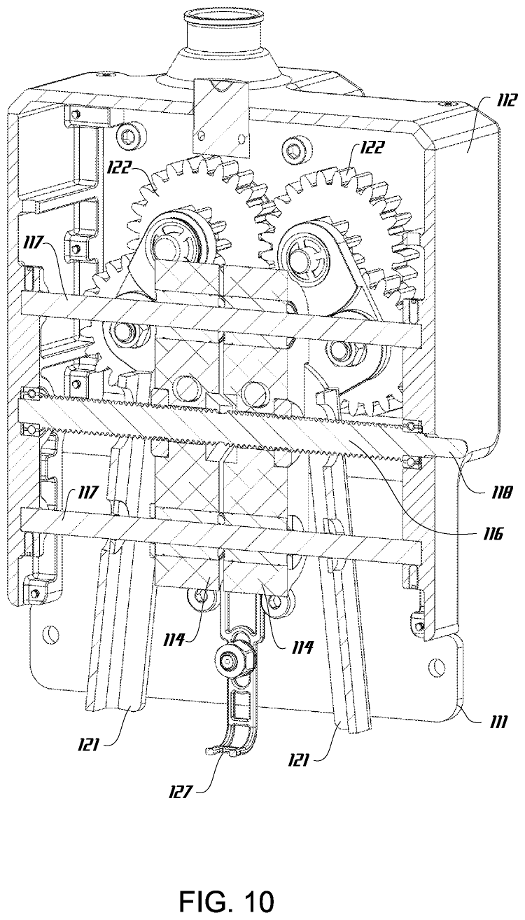

FIG. 8 is a front perspective view of an embodiment of the Print Head assembly 110. The assembly 110 includes a Print Head Main Body 112, which encloses the internal mechanisms, and a Main rear mounting plate 111 for attachment to a host printer's gantry. Centrally positioned and shown in a closed or clamped state are the Articulating Clamp Arms 114. In this state, a Tool Holder 150 is shown fully seated and secured within the Print Head's Conical alignment and indexing receptacle 136. The front face of the assembly 110 is formed by the Front cooling-duct and extruder wheels covers 135 and features a pair of Part Cooling Fans or Blowers 132. These fans direct airflow through the Part Cooling Ducts/Air Nozzles 134 towards the Nozzle Tip 160 of the installed Tool Holder 150. At the lower-most portion of the assembly 110, the Hotend Assembly/Heater 126 is visible, positioned to thermally engage the Hot End of Nozzle 158 of the seated Tool Holder 150. Also visible on the side of the Print Head Main Body 112 are key mechanical interface points: the Print Head to TCC mechanical latch attachment point 113 and the Clamping Screw Drive Engagement Feature 118, which facilitates the automated tool change process. This view also indicates section lines 9-9 and 10-10, which correspond to the cross-sectional views provided in subsequent figures, FIGS. 9 and 10.

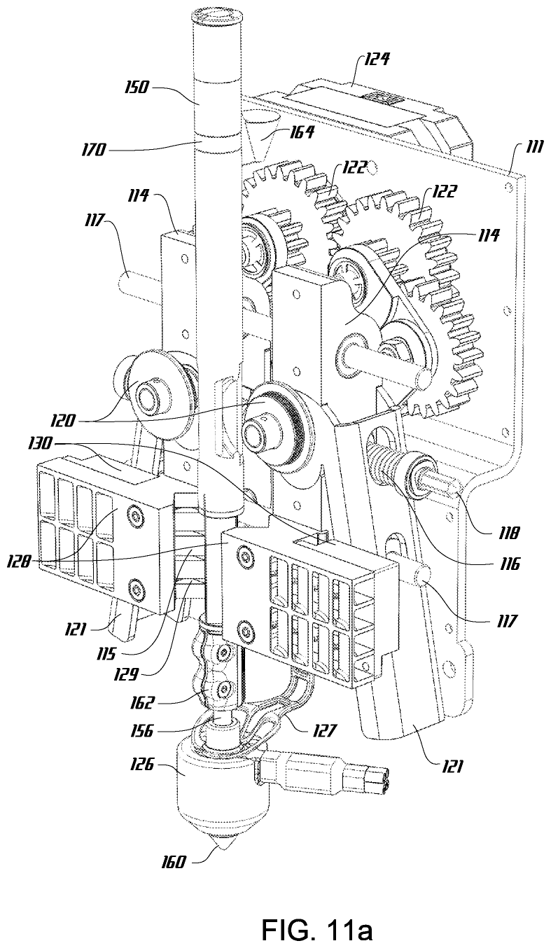

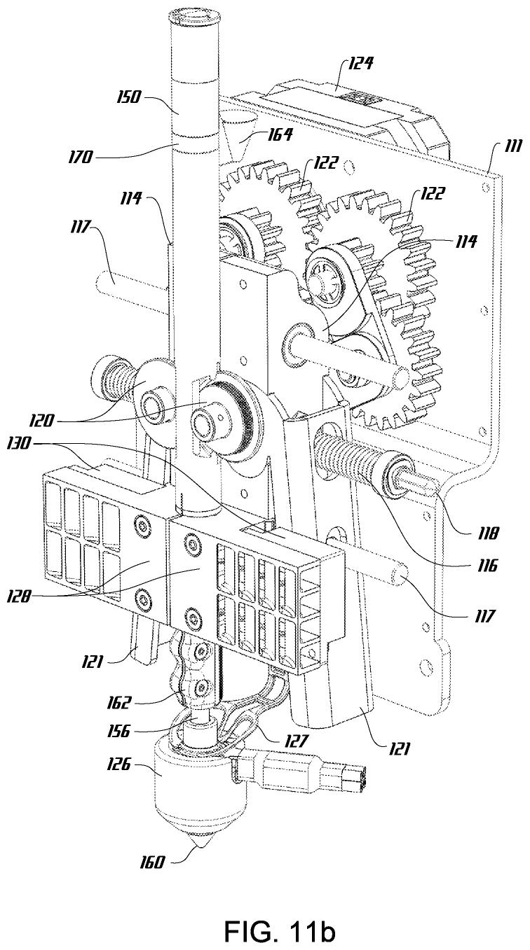

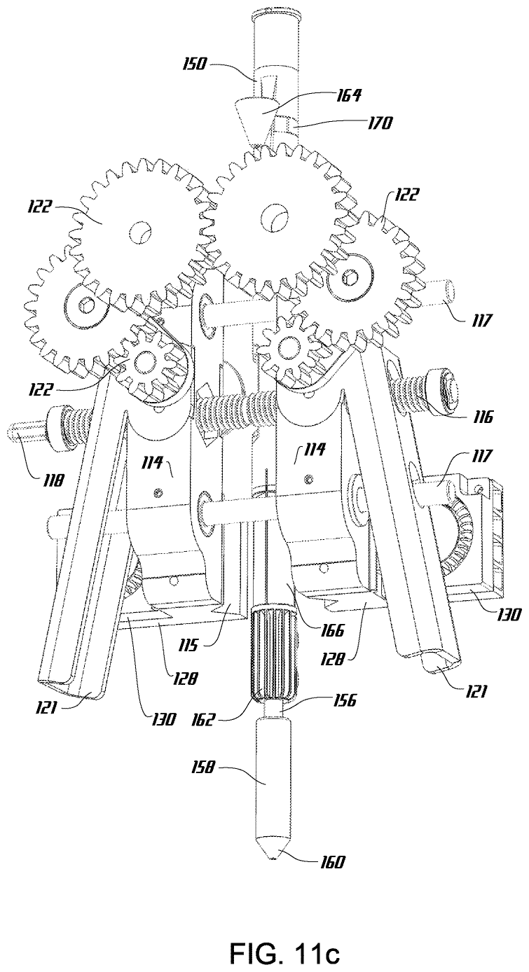

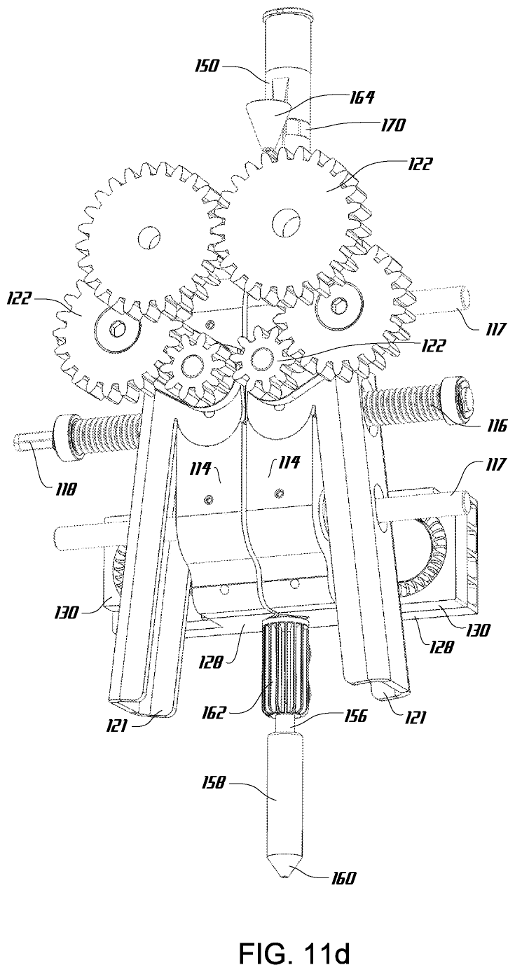

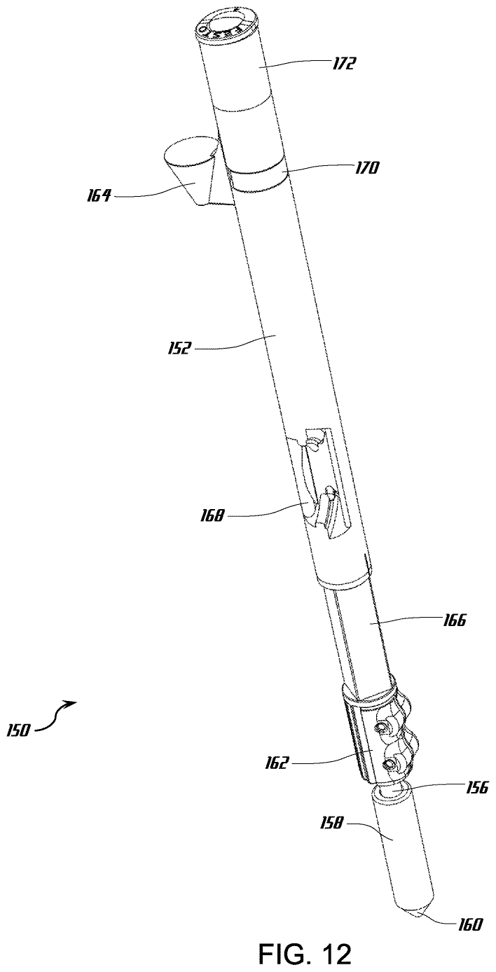

FIG. 9 presents a cross-sectional view of the Print Head Assembly 110, taken along line 9-9 of FIG. 8, which is a cut through the centerlines of the Clamping Heatsinks 128, the Tool Holder 150, and the Dual Extruder Drive Wheels (interlocking) 120. This view reveals the internal arrangement of the assembly with a Tool Holder 150 securely clamped in its operational position. The Extruder Drive Wheels 120 are shown engaged with the Tool Holder 150, positioned to access and drive a filament through the internal filament guide tube. In other embodiments, the rotation of these drive wheels 120 may be repurposed to actuate tool-specific mechanisms. This view also clearly distinguishes between the system's two primary cooling circuits. The upper Part Cooling Fans/Blowers 132 direct airflow via Part Cooling Ducts 134 to the Nozzle Tip 160 to cool the extruded material. The lower Heatsink Cooling Fans 130 are responsible for cooling the Clamping Heatsinks (128, shown in FIG. 11a) of the clamping mechanism, thereby preventing excessive heat (“heat creep”) from traveling up the body of the Tool Holder 150. At the bottom of the assembly, the Hotend Assembly/Heater 126 is shown in section, surrounding the Hot End of Nozzle 158 (visible in FIG. 12) of the Tool Holder 150 to melt feedstock material just before extrusion.

The clamping mechanism of the Print Head Assembly 110 provides both a mechanical clamping function and a thermal management function. The Articulating Clamp Arms 114 are not merely structural components for securing a tool holder, they are integrally designed to function as the primary Heatsinks 128 for the system. When clamping a tool holder, the large, flat heatsink clamping surfaces 115 of the arms 114 make direct, high-pressure contact with the corresponding surfaces of the tool holder's clamping section 166. This creates a highly efficient thermal pathway, allowing waste heat from a thermal tool, such as a filament nozzle, to be actively drawn away and dissipated by the heatsinks 128, which are themselves cooled by Heatsink Cooling Fans 130. This consolidation of the mechanical clamping and thermal management functions into a single sub-assembly is a key design choice of the present invention. By centralizing the thermal management capacity within the Print Head, the system enables the use of simple, lightweight, and inexpensive passive tool holders, which is fundamental to the system's modularity and scalability. This architectural decision significantly reduces the cost, complexity, and physical mass of each individual tool holder, making it practical and economical to maintain a large library of pre-configured tools ready for automated use.

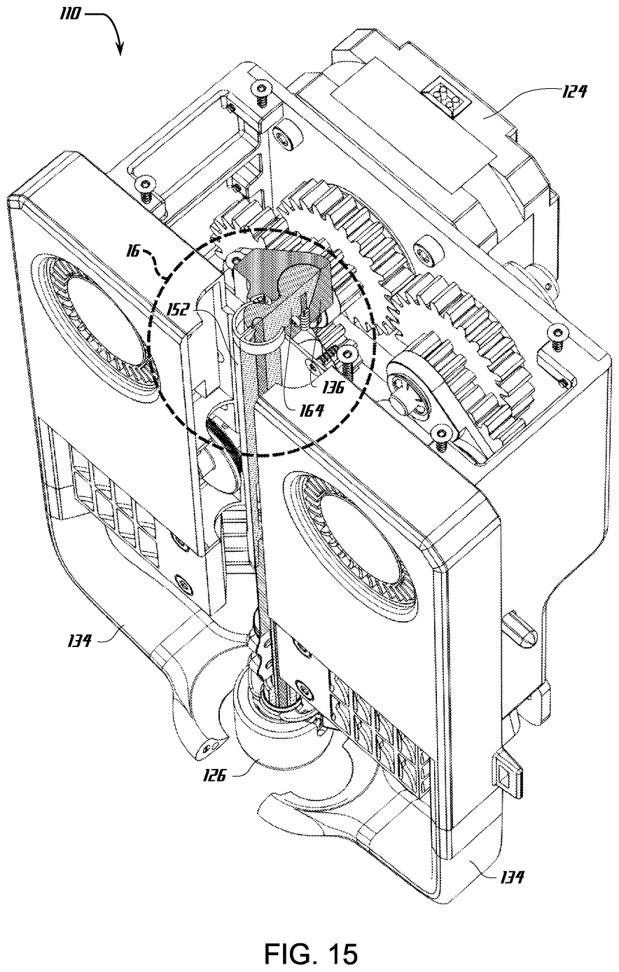

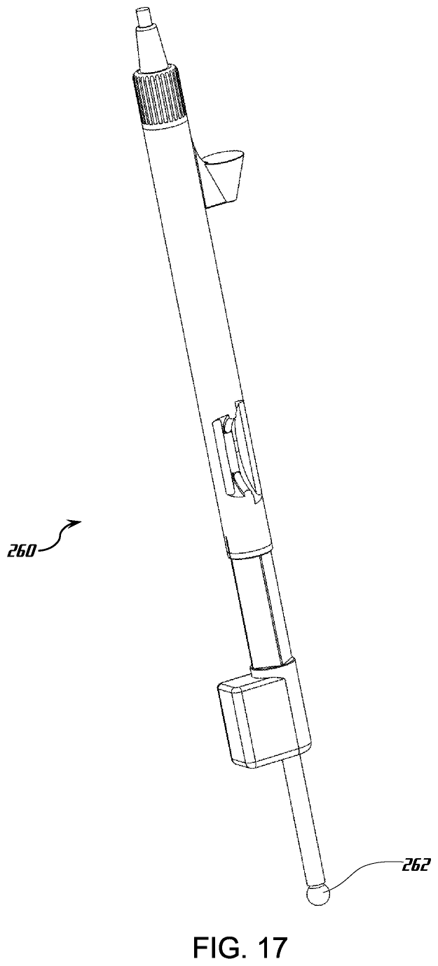

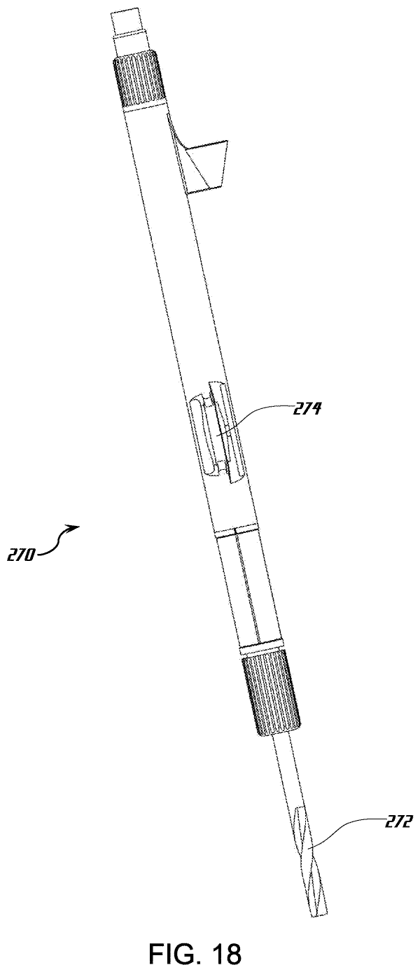

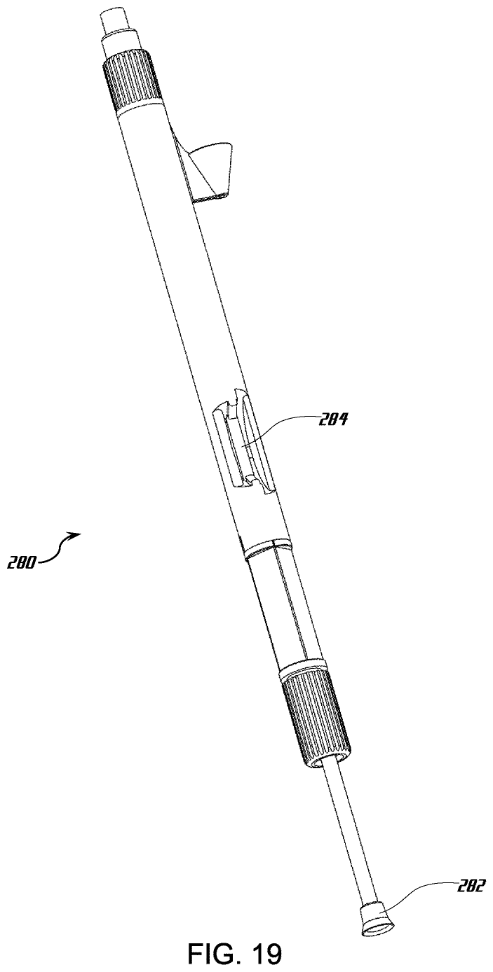

The Extruder Drive Wheels 120 and their associated drive motor (124, shown in FIG. 15) can be repurposed to actuate tool-specific mechanisms when a non-feedstock tool holder is utilized. In such further embodiments, as illustrated by the alternative tool holders in FIGS. 17-19, the rotation of the Extruder Drive Wheels 120 is used to actuate tool-specific mechanisms. For example, when using the Flexdrive driven drill-mill tool (270, FIG. 18), the drive wheels 120 can engage an On/Off/Speed Control switch 274. By commanding the host printer's extruder axis (‘E’ axis) to ‘extrude’ or ‘retract’ at various amounts via standard G-CODE, the system can precisely modulate the rotational speed of the cutting bit, enabling variable-speed machining operations. Similarly, when using the Vacuum type Pick-N-Place tool (280, FIG. 19), the drive wheels 120 can engage a Vacuum Control switch 284 to programmatically turn a vacuum source on or off for grasping and releasing components, and rotating the vacuum nozzle tube to align held components into position if required. Therefore, the function of the Extruder Drive Wheels 120 may be specialized and tool-dependent, leveraging the same core drive system to control a variety of distinct printing, cutting, or automated assembly tasks.

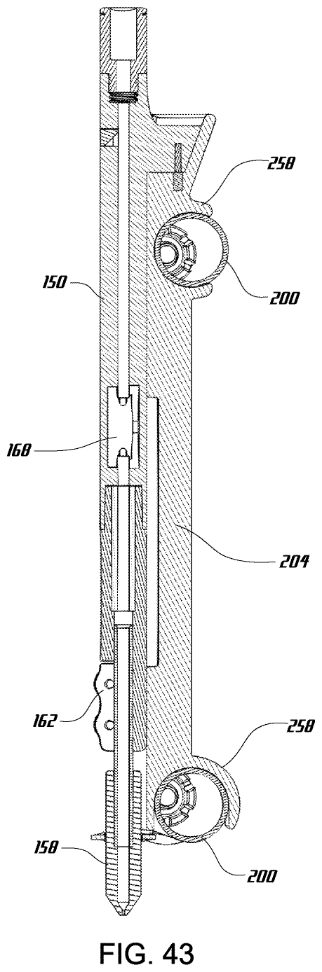

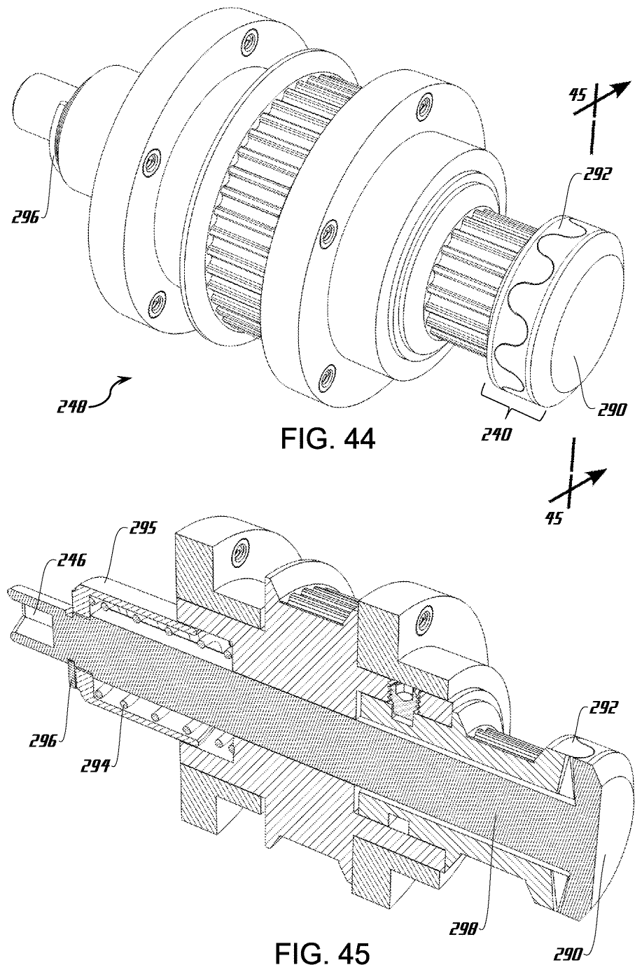

FIG. 10 presents a cross-sectional view of the Print Head Assembly 110, taken along line 10-10 of FIG. 8. This view reveals the internal mechanics of the articulating clamping and drive transmission systems, which are housed within the Print Head Main Body 112 and affixed to the Main rear mounting plate 111. The cross-section is taken through the centerline of the clamping mechanicals, including the Dual-Threaded Clamping Screw 116 and the Dual clamping arms steel guide rods 117, with the Articulating Clamp Arms 114 shown in their closed position. The Clamping Screw Drive Engagement Feature 118 is also visible. This feature is configured to engage with a corresponding drive socket on the Tool Changing Transmission (248, shown in FIG. 44). This mechanical engagement controls the system's function multiplexing: when the feature 118 is fully inserted into the drive socket, it physically disengages a normally-on, spring-loaded clutch in the transmission, thereby redirecting the drive output from the tool change stepper motor to the clamping screw 116. While a dual-threaded screw is shown as the clamping actuator, it is contemplated that other types of mechanical actuators could be used to drive the articulating clamp arms. When disengaged from the socket, the clutch re-engages by default, directing the motor's output to the Tool Changer Carriage (TCC). Also illustrated are the Extruder wheel release levers 121 and the Hotend heat-break mounting arm 127. In preferred embodiments, these levers 121 are spring-loaded (springs not shown), acting as cams to apply pressure to the Extruder Drive Wheels, keeping pressure on the filament at an optimum level during use. Levers 121 also allow for manual retraction of the wheels, enabling a user to relieve wheel pressure on the filament and easily load or unload filament by squeezing the levers 121 together as further described in FIG. 11a.

FIG. 11a provides a perspective view of the internal mechanics of the Print Head Assembly 110, specifically illustrating the assembly in its open or unclamped state. In this view, the Articulating Clamp Arms (Clamping Jaws) 114 are shown in their fully open state, creating a clear path for a Tool Holder 150 to be inserted or removed. This view also illustrates the function of the Extruder wheel release levers 121. While these spring-loaded levers (springs not shown) normally act as cams to apply pressure to the extruder drive wheels during operation, they can be manually squeezed together, like a plier, to retract and disengage the Extruder Drive Wheels 120 from the Tool Holder 150. At any point in the open/close cycle the drivetrain remains unbroken. This configuration represents a key transitional state, such as immediately after a tool has been loaded (i.e., post-LOAD, pre-CLAMP), or immediately after the clamps have been released to allow for the tool's removal (i.e., post-RELEASE, pre-UNLOAD), enabling easy manual loading or unloading of filament. Also visible is the Tool Holder 150 with its Conical alignment and indexing Mounting Feature 164, the Dual-Threaded Clamping Screw 116 that drives the clamping motion, and the Hotend Assembly/Heater 126. Further illustrated are bypass slots 129 in the clamp area of heatsinks for direct nozzle air-cooling.

FIG. 11b provides a perspective view of the internal mechanics of the Print Head Assembly 110, illustrating the assembly in its closed or clamped state, in contrast to the open state shown in FIG. 11a. This state is achieved by the rotation of the Dual-Threaded Clamping Screw 116, which drives the linear inward movement of the Articulating Clamp Arms (Clamping Jaws) 114 along the guide rods 117. This linear motion securely clamps the Tool Holder 150 by pressing the heatsink clamping surfaces (115, visible in FIG. 11c) against it, and brings the Extruder Drive Wheels 120 into firm engagement with the Tool Holder's Extruder Wheel Access Slots (168, visible in FIG. 12). A key feature of the drive mechanism is that the Extrusion Transmission Gears 122 can remain operatively engaged to drive the Extruder Drive Wheels 120 throughout the travel width of the clamp arms, not only in the fully clamped position, thereby enabling the potential use of wider tools or tool-specific functions that may operate at various clamp widths. This configuration represents the primary operational state of the Print Head 110, where a tool is securely held and the drive system is engaged, ready to perform its designated function.

FIG. 11c provides a rear perspective view of the articulating gear-drive mechanism of the Print Head assembly 110, shown in its open or unclamped state. This rear view illustrates the Articulating Clamp Arms (Clamping Jaws) 114 in their fully open position, having moved linearly outward along their guide rods 117 as driven by the Dual-Threaded Clamping Screw 116. In this open configuration, the set of Extrusion Transmission Gears 122, which are mounted on their respective clamp arms 114, are clearly shown. This state corresponds to the unclamped position shown in FIG. 11a and allows for the insertion or removal of a Tool Holder 150 between the now-open clamping surfaces 115 of the Heatsinks 128. The upper portion of the Tool Holder 150 is also visible, including its Conical Mounting Feature 164.

FIG. 11d is a rear perspective view corresponding to FIG. 11c, but showing the articulating gear-drive mechanism of the Print Head assembly 110 in a closed and clamped state. This state corresponds to the clamped position shown in FIG. 11b, whereby the mechanism is configured to both securely hold the tool holder and simultaneously provide power to the extrusion drive system.

FIG. 12 provides a detailed perspective view of a Tool Holder 150, specifically configured as a filament-based feedstock tool. The Tool Holder 150 is the core modular component of the system, designed for quick and repeatable interchangeability. Specifically, the Tool Holder 150 allows for the pre-configured filaments and nozzles to be swapped in and out quickly.

At its upper end, the Tool Holder features a Feedstock Delivery Tube Connector 172 for connecting a filament guide tube, and an Out-of-Feedstock (OOF) Sensor Ring 170, which is part of a circuit for detecting when the filament supply runs out (i.e., when the end of filament passes below the Sensor Ring 170).

The Main Tool holder Body 152 includes the Conical alignment and indexing Mounting Feature 164, which is designed to mate with a corresponding conical receptacle in the Print Head for precise and repeatable positioning. The body also features Extruder Wheel Access Slots 168, which allow the Print Head's drive wheels to engage and control the feedstock material passing through the tool.

The lower portion of the Tool Holder comprises the Aluminum Clamping Section 166, which presents the profile for being secured within the Print Head's clamping mechanism. This section is attached to the Aluminum Nozzle Chuck 162, which secures the replaceable nozzle assembly. The nozzle tube itself is functionally zoned, consisting of a Heat-Break Section 156 to isolate the upper part from heat, a Hot End of Nozzle 158 where melting occurs, and terminating in the Nozzle Tip 160 from which material is extruded.

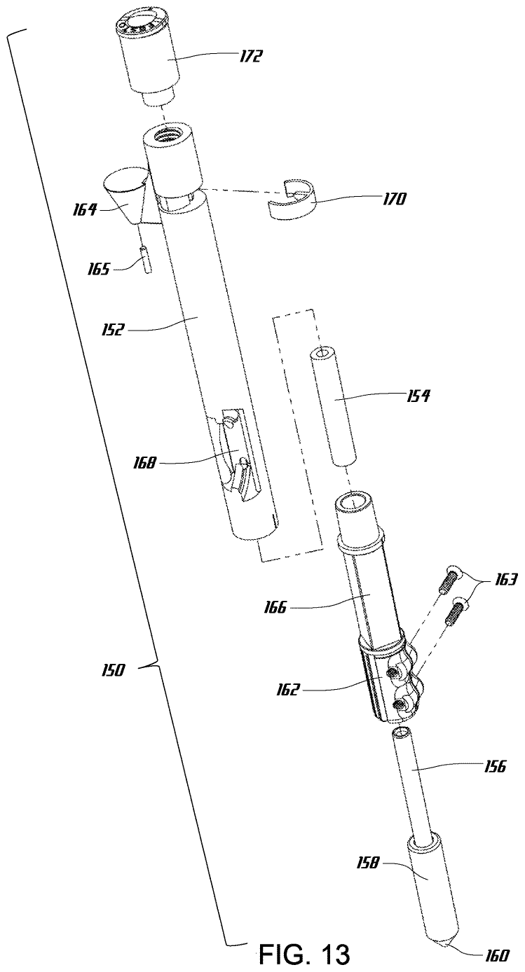

FIG. 13 is an exploded view of the filament-based Tool Holder 150, showing its constituent parts and assembly sequence. This view clarifies the modular construction of the component.

The Main Tool holder Body 152 forms the central chassis and contains the Extruder Wheel Access Slots 168. As shown in the exploded view, the Internal PTFE filament guide tube 154 is housed entirely within the lower assembly, specifically the Aluminum Clamping Section 166 and Aluminum Nozzle Chuck 162, and does not extend into the Main Tool holder Body 152. This guide tube 154 serves a dual function: it provides a low-friction path for the filament feedstock and thermally insulates the incoming filament, preventing premature softening from heat conducted into the surrounding aluminum components before the filament reaches the Heat-Break Section of the Nozzle 156. At the top of the assembly, the Feedstock Delivery Tube Connector 172 provides the interface for incoming filament, while the Out-of-Feedstock (OOF) Sensor Ring 170 is positioned just below it.

The Conical alignment and indexing Mounting Feature 164 is shown separated, along with the Carbon steel magnetically attracted tool holder hold-in pin 165 that is seated within it to ensure magnetic coupling with the Print Head.

The lower assembly consists of the Aluminum Clamping Section 166, which presents the square profile for clamping within the Print Head, and an integrally formed Aluminum Nozzle Chuck 162. The Nozzle chuck compression screws 163 are configured to compress the chuck 162 around the Heat-Break Section 156 of the replaceable nozzle assembly, thereby securely fastening it within the Tool Holder. The chuck 162, in turn, secures the full replaceable nozzle assembly, which comprises the Heat-Break Section 156, Hot End of Nozzle 158, and Nozzle Tip 160. This exploded view demonstrates how the core functional elements are assembled into a single, standardized, and interchangeable unit.

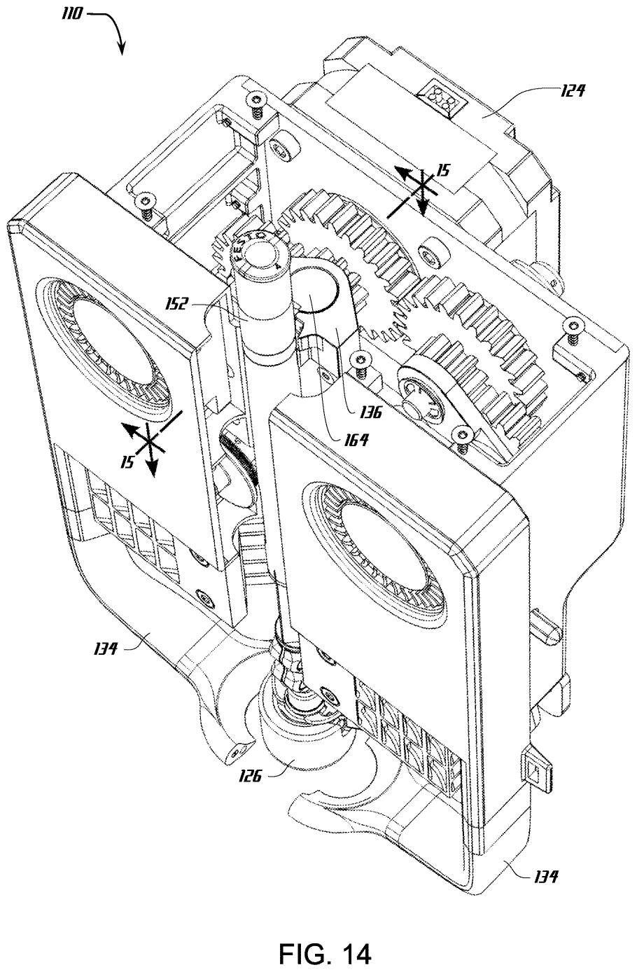

FIG. 14 provides a detailed perspective view of the Print Head Assembly 110 with a Tool Holder 150 installed in the unclamped position. This view represents a key transitional state during the tool change cycle.

The Tool Holder's Main Tool holder Body 152 is shown seated within the Print Head. The Conical alignment and indexing Mounting Feature 164 of the tool is mated with the corresponding Conical alignment and indexing receptacle 136 of the Print Head. This magnetic and geometric interface holds the Tool Holder 150 in a precise, pre-clamped position, ensuring it is correctly aligned for the subsequent clamping operation.

This configuration illustrates the state of the system after the Tool Changer Carriage has loaded a new tool into the Print Head 110, but before the clamping mechanism has been activated to secure it for operation. Also visible are the Extruder Stepper Motor 124 and the Part Cooling Ducts/Air Nozzles 134. The view indicates the location of the cross-section 15-15, which is detailed further in FIG. 15.

FIG. 15 is a perspective view of the Print Head Assembly 110, identical to that shown in FIG. 14, with the Conical alignment and indexing Mounting Feature 164 of the tool mated with the corresponding Conical alignment and indexing receptacle 136 of the Print Head, both cross-sectioned, illustrating the engagement of the Tool Holder in its unclamped, pre-clamp position.

This view introduces a detailed callout, indicated by the dashed circle labeled 16. The callout magnifies the critical interface area where the upper portion of the Tool Holder 150 is seated within the Print Head assembly. Specifically, it focuses on the engagement of the Tool Holder's Conical alignment and indexing Mounting Feature 164 within the Print Head's Conical alignment and indexing receptacle 136.

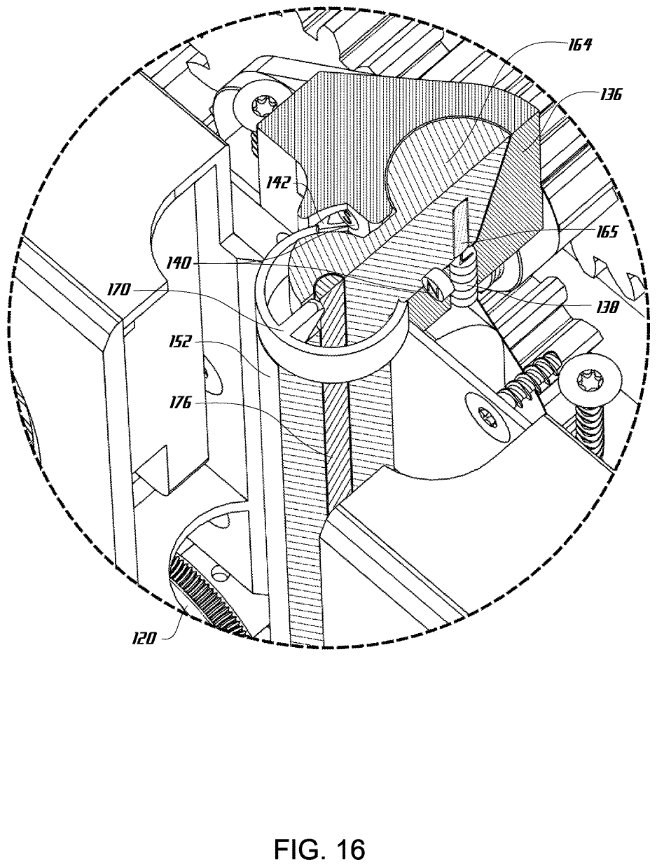

This magnified area, which is shown in greater detail in the subsequent FIG. 16, illustrates the mechanism responsible for the precise alignment and temporary magnetic retention of the Tool Holder before the main clamping arms are activated.

FIG. 16 is a magnified, cross-sectional detail view of the interface between the Tool Holder and the Print Head, as indicated by callout 16 in FIG. 15, shown in the unclamped, pre-clamp state. This view details the mechanical and electrical systems integrated into this single connection point.

The view illustrates the precise mating of the Tool Holder's Conical alignment and indexing Mounting Feature 164 within the Print Head's Conical alignment and indexing receptacle 136. The temporary magnetic retention is achieved by the attraction between the Tool Holder Alignment Magnet 138, situated within the receptacle 136, and the Carbon steel magnetically attracted tool holder hold-in pin 165, which is seated inside the conical feature 164.

This view also clearly illustrates the components of the Out-of-Feedstock (OOF) sensor system. The OOF Sensor Ring 170, located on the Main Tool holder Body 152, is positioned adjacent to the Tool Holder OOF ring actuation magnets 140 and the Grounding OOF contacts 142, which are housed within the receptacle 136. This arrangement allows the magnets 140 to pull the conductive sensor ring 170 into contact with the grounding contacts 142 to complete an electrical circuit when filament is no longer present to physically block it, thereby signaling an out-of-feedstock condition. Feedstock Material 176 is also shown which may be, for example, filament.

Consistent with the unclamped state, the Extruder Drive Wheel 120 is shown retracted and not engaged with the body of the tool holder.

FIGS. 17-19 provide perspective views of several alternative embodiments of the Tool Holder, which serve as examples of the system's modularity and multi-functional capabilities. While each tool, including the Limit-switch type bed leveling probe tool 260 of FIG. 17, the Flexdrive driven drill-mill tool 270 of FIG. 18, and the Vacuum type Pick-N-Place tool 280 of FIG. 19, maintains a standardized upper body for compatibility with the Print Head's clamping and alignment mechanisms, their lower portions are configured with interchangeable, function-specific tool ends. This architecture is intentionally non-comprehensive and is designed to bring a wide variety of technologies to the fabrication process. The system enables the swapping in and out of not only the appropriate feedstock, but also various sensors and tools as required during the build. Examples of other supported tool types include, but are not limited to: applicators for photo-reactive gels with associated curing lasers; dimensional or temperature measuring sensors; adhesive or paint applicators; and other material-removing tools such as sanders or circular saws. This design allows the system to seamlessly switch between different operational modes, such as probing, subtractive machining, and automated assembly, thereby transforming the host printer into a versatile, multi-process fabrication device.

FIG. 17 illustrates a perspective view of an alternative embodiment of a Tool Holder, specifically a Limit-switch type bed leveling probe tool 260. This tool demonstrates the modularity and multi-functionality of the tool-changing system.

The probe tool 260 maintains the same standardized upper body as the filament tool holder 150, ensuring full compatibility with the Print Head's clamping and alignment mechanisms. The lower portion of the tool 260, however, is adapted for a sensing function instead of material extrusion. Tool 260 incorporates a limit-switch mechanism, which is actuated when a probe 262 at its distal end makes contact with the build platform or a printed object.

This tool 260 is designed to be automatically loaded into the Print Head to perform automated bed leveling, Z-height calibration, or other probing operations before or during a print job, after which it can be stored and replaced with a different tool, such as a filament extruder. In further embodiments, the distal end of tool 260 may further comprise of depth gauges, thermometers, cameras, and related 3D printing sensors.

FIG. 18 illustrates a perspective view of another alternative embodiment of a Tool Holder, specifically a Flexdrive driven drill-mill tool 270. This tool further demonstrates the modular nature of the system, enabling subtractive manufacturing processes such as drilling or milling within a 3D printing workflow.

The drill-mill tool 270 maintains the standardized upper body and mounting features common to all Tool Holders, ensuring it can be automatically loaded, clamped, and unloaded by the Print Head and Tool Changer Carriage.

The lower portion of the tool 270 is distinctively configured with a spindle and a cutting bit 272. The “Flexdrive driven” designation indicates that, when in use, the tool is mechanically coupled to a flexible drive shaft, which is in turn connected to an external motor. This provides the high-speed rotation necessary for cutting operations. This capability allows the system to perform precise material removal on a printed part, for example, to create clean holes, flatten surfaces, or perform other machining tasks, thereby integrating additive and subtractive manufacturing in a single, automated process.

In preferred embodiments, the lower portion of a non-feedstock tool, such as the Flexdrive driven drill-mill tool 270, is configured with an attachment means, such as a threaded chuck or collet, for interchangeably securing various end-effectors. This modularity allows a single tool holder body to be equipped with a variety of tools like drill bits 272, end mills, sanders, and circular saws. This embodiment leverages the host printer's “E” axis extruder command channel to provide tool control input.

In one such embodiment, this control is achieved mechanically by leveraging the otherwise idle Extruder Stepper Motor 124 and Extruder Drive Wheels 120 of the Print Head. As shown with tool 270, the Extruder Drive Wheels 120 are positioned to physically engage with an On/Off/Speed Control switch 274 integrated into the tool body. The system leverages standard GCODE commands for the extruder (‘E’ axis) to provide nuanced control over the tool's external motor. By default, when the drive wheels are disengaged from the switch, the tool is off. Commanding the E-axis motor to rotate in a forward, or ‘extrude,’ direction engages the switch to enable power to the external motor. Continued rotation in the ‘extrude’ direction corresponds to an increase in the rotational speed (RPM) of the cutting bit 272. Conversely, commanding the motor to rotate in a reverse, or ‘retract’, direction decreases the RPM until the tool is turned off. This control scheme enables variable-speed machining and a similar principle of mechanical engagement is utilized with other tools, such as the Vacuum type Pick-N-Place tool 280, where the drive wheels 120 can engage a Vacuum Control switch 284 to programmatically turn a vacuum source on or off.

FIG. 19 illustrates a perspective view of another alternative embodiment of a Tool Holder, specifically a Vacuum type Pick-N-Place tool 280. This tool highlights the system's capability to perform automated assembly tasks.

The pick-and-place tool 280 maintains the standardized upper body and mounting features common to all Tool Holders, ensuring it can be automatically loaded, clamped, and unloaded by the system. The upper portion of the tool is configured with a port for a vacuum line, similar to how feedstock is delivered to the filament based tool holder, terminating in a suction cup or similar gripper.

In operation, a vacuum 282 is applied through the tool to pick up discrete components, such as electronic parts, threaded inserts, or other pre-manufactured objects. The printer's gantry then moves the tool to a specific location within the build area, where the vacuum is released to place the component. This allows for the automated insertion of hardware and electronics directly into a 3D printed object during the fabrication process. The system's versatility is further enhanced by leveraging the Print Head's drive mechanism. The Extruder Drive Wheels 120 can engage a Vacuum Control switch 284 on the tool body, allowing the printer's E-axis motor to programmatically turn the vacuum on or off. In addition, the same drive mechanism can be used to rotate the tool about its vertical axis. This rotational capability allows for precise angular orientation of the held component before placement, enabling the automated assembly of components that are not radially symmetric and creating more complex, fully assembled products in a single operation.

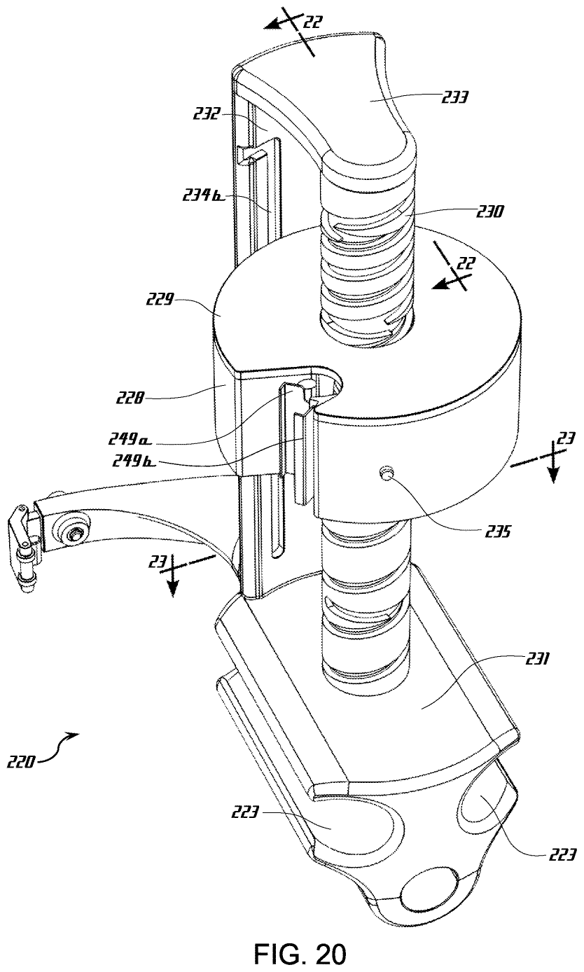

FIG. 20 provides a detailed perspective view of the Tool Changer Carriage (TCC) 220, which is the primary robotic component responsible for handling and transporting Tool Holders within the system.

The central feature of the TCC 220 is the Multi-function Cylindrical Cam 230, which is surrounded by the Rotary Carousel 228 and housed within the stationary Carousel Support Tower 232. The system's complex motion is achieved by separating the driving and guiding functions. The vertical movement of the carousel is driven by the rotation of the Cylindrical Cam 230. The path of this movement is constrained and guided by the engagement of TCC guide slot pins 235, which protrude from the carousel, with vertical Guide Slots 234 machined into the tower 232. This architecture translates a single rotational input into a precisely controlled sequence of vertical and rotational movements.

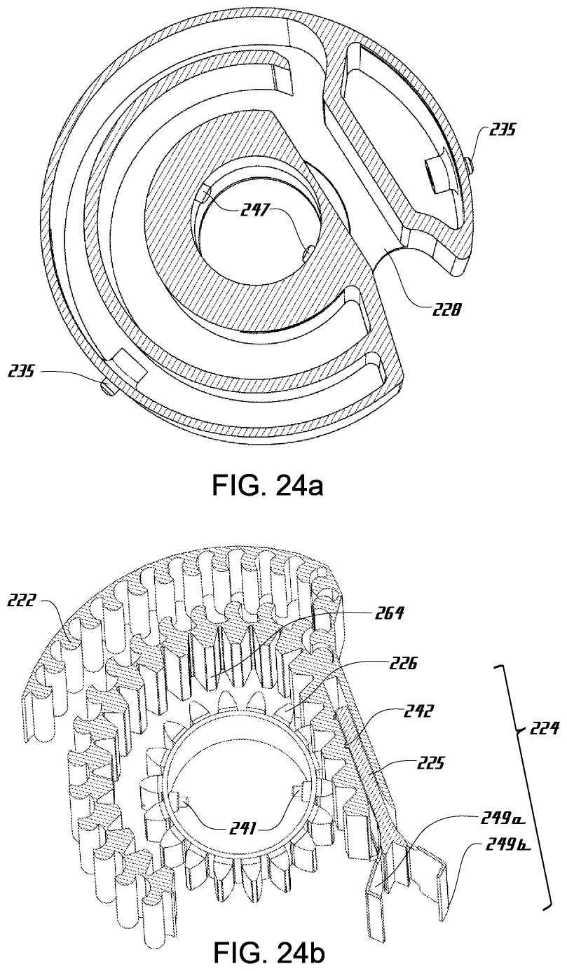

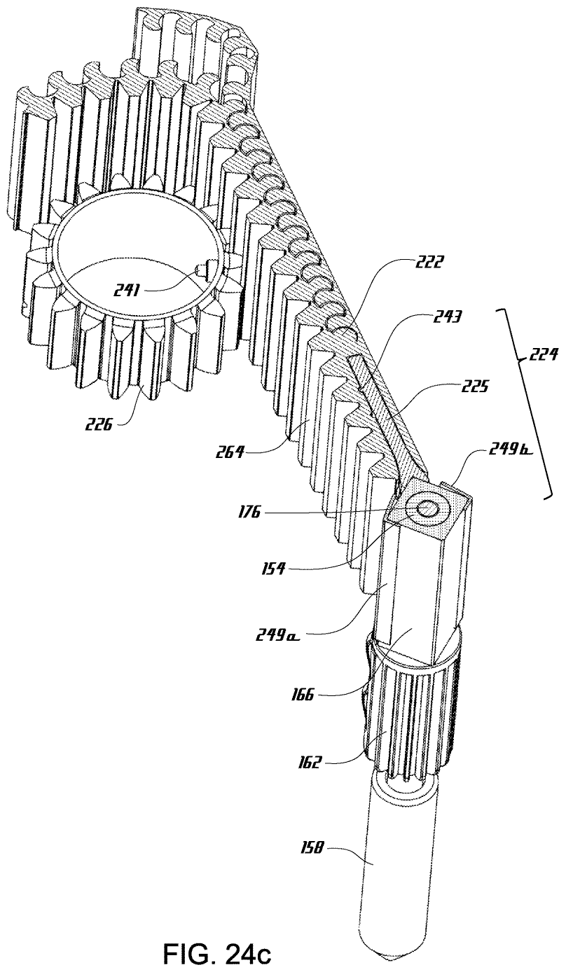

In this particular view, the gripper assembly (224, illustrated in FIGS. 24b-26) is shown in an extended position, with the two gripper arms 249a,b of the gripper assembly ready to engage or disengage a Tool Holder. The TCC Way bushings 223 are also visible, which facilitate the smooth sliding motion of the entire TCC assembly along the Docking Beam. The view also indicates section lines 22-22 and 23-23, which correspond to the cross-sectional views provided in subsequent figures.

The TCC 220 assembly is constructed above a central, stationary TCC Base 231, which includes the TCC Way bushings 223. Its integrated vertical structure, the Carousel Support Tower 232, contains vertical Guide Slots 234 that constrain the motion of the mobile components. In preferred embodiments, these Guide Slots, such as dockside guide slot 234a and printside guide slot 234b, extend at least partially the length of the inward-facing surface of the Carousel Support Tower 232. A Rotary Carousel 228 is mounted coaxially to the Carousel Support Tower 232 and is capable of both vertical translation along it and rotation about its central axis. The top of the Rotary Carousel 228 is enclosed by a Rotary Carousel Cover 229.

The vertical and rotational motion of the Rotary Carousel 228 is driven by the Multi-function Cylindrical Cam 230, which is positioned centrally within the assembly. The rotation of the Cylindrical Cam 230 imparts vertical motion to the Rotary Carousel 228, whose inner surface engages with helical grooves on the cam's exterior. This vertical translation is guided and constrained by one or more TCC guide slot pins 235 that protrude from the Rotary Carousel 228 and ride within the Guide Slots 234 of the Carousel Support Tower 232. This pin-and-slot engagement controls the path of motion, enabling the carousel to rotate between different orientations only at specific vertical elevations where the pins can transition between sets of vertical guide slots.

At the top of the assembly, a Carousel Support Tower Top and Cylindrical Cam upper bearing 233 provides support and alignment for the upper end of the Cylindrical Cam 230.

The two gripper arms 249a,b of the gripper are the mechanisms that physically grasp the Tool Holder. In this figure, the gripper arms 249a,b are shown in an open state, with the gripper (224, illustrated in FIGS. 24b-26) protruding slightly from the end of the fully retracted Flexible Interlocking Rack Gear 222, currently retracted and coiled within the Rotary Carousel 228. Although the transport mechanism is shown as a flexible interlocking rack gear, other linear actuators could be employed to extend and retract the gripper, such as a telescoping arm, without departing from the scope of the invention. At the base of the TCC 220, TCC Way bushings 223 are shown. These bushings interface with the Tool Changer Carriage Ways 221, allowing the entire TCC 220 assembly to slide smoothly along the X-axis of the docking system.

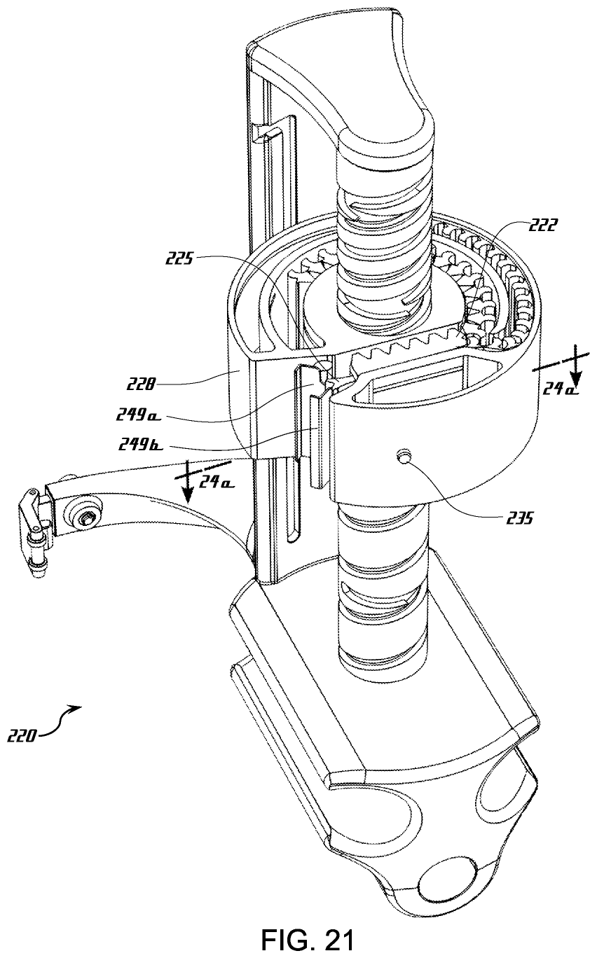

FIG. 21 shows another perspective view of the TCC 220, with the Rotary Carousel Cover 229 removed to illustrate the internal components of the Rotary Carousel 228. This view highlights the Flexible Interlocking Rack Gear 222, shown here in its fully retracted and coiled state within the Rotary Carousel 228.

The Flexible Interlocking Rack Gear 222 is comprised of two interlocking halves that can separate to coil into a small circular storage space, and then zip together to form a rigid linear actuator or push-rod when extended. This rack gear is connected to a Gripper core 225, which in turn is connected to the two gripper arms 249a,b of the gripper (224, illustrated in FIGS. 24b-26). In the retracted state, the gripper (224, illustrated in 24b-26) is housed within the body of the Rotary Carousel 228. When actuated, the Flexible Interlocking Rack Gear 222 extends linearly, pushing the gripper outward to engage with a Tool Holder.

The TCC's 220 complex sequence of movements is achieved through the mechanical synergy between the Multi-function Cylindrical Cam 230, the Rotary Carousel 228, the Flex Rack Drive Pinion 226, and the Flexible Interlocking Rack Gear 222. The system is designed such that the single rotational input of the Cylindrical Cam 230 is selectively translated into different outputs, either vertical or rotational carousel motion or horizontal rack actuation, based on physical constraints imposed by the Carousel Support Tower 232.

Also visible are the TCC guide slot pins 235. As previously described, these pins engage with the vertical Guide Slots 234 of the Carousel Support Tower 232 to precisely control the vertical and rotational path of the entire Rotary Carousel 228 assembly. The vertical motion of the Rotary Carousel 228 is governed by the engagement of its TCC guide slot pins 235 within the vertical Guide Slots 234 of the Carousel Support Tower 232. When the guide pins 235 are free to travel within these vertical slots, the rotation of the Cylindrical Cam 230 imparts a direct vertical (up or down) translation to the Rotary Carousel 228 via the helical grooves on the cam's surface. In this state, rotational force is not transferred to the Flex-Rack Drive Pinion 226.

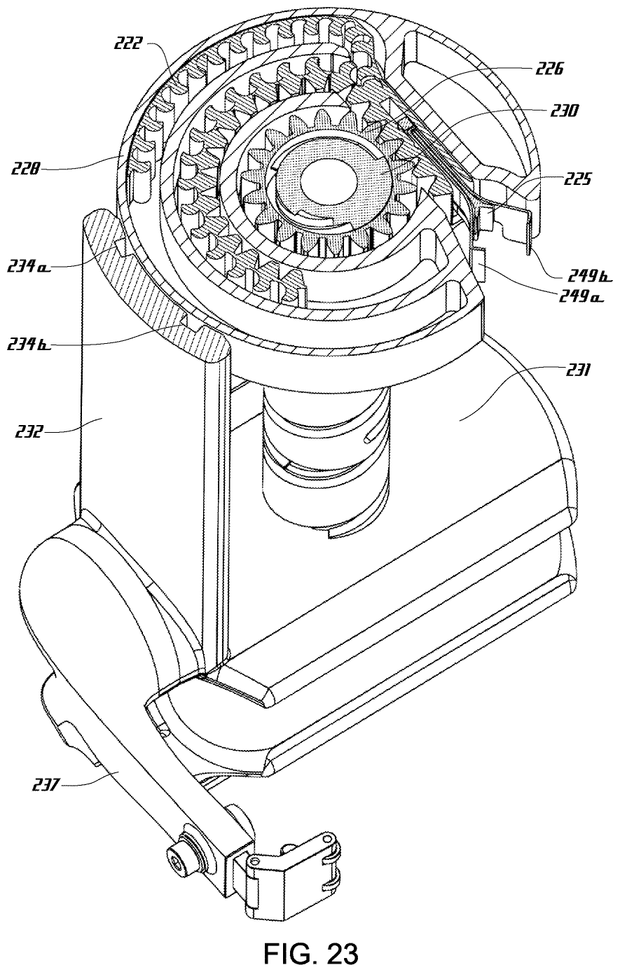

As best illustrated in FIG. 23, the system transitions to horizontal actuation when the vertical movement of the Rotary Carousel 228 is constrained. At specific vertical elevations (e.g., the “extension height” or “docked height”), the guide pins 235 are no longer aligned with a continuous vertical slot, preventing further vertical travel. With the carousel's vertical motion arrested, the continued rotation of the Cylindrical Cam 230 is instead selectively transferred to the Flex-Rack Drive Pinion 226. The rotation of this pinion 226 then engages the teeth 264 of the Flexible Interlocking Rack Gear 222, driving it linearly to extend or retract the Gripper (224, illustrated in FIGS. 24b-26). The design enables a single motor to execute a multi-axis robotic sequence, embodying the inventive principle of using the cam to simultaneously lift (or position) the carousel and drive the pinion.

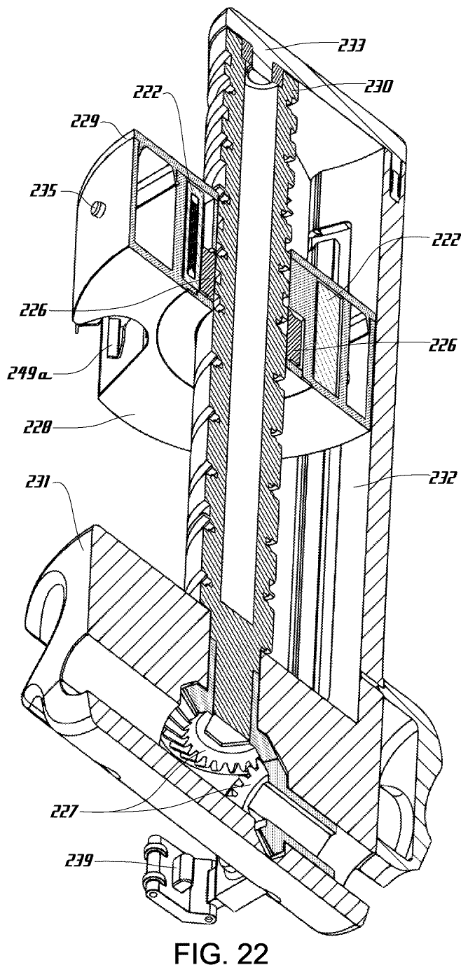

FIG. 22 presents a cross-sectional view of the TCC 220, taken along line 22-22 of FIG. 20, illustrating the internal arrangement of its primary functional components. The assembly is built upon the stationary TCC Base 231, which houses the rotatable, multi-function Cylindrical Cam 230 along its central axis. The top of the Cylindrical Cam 230 is supported by the Carousel Support Tower Top and Cylindrical Cam upper bearing 233.

Coaxially mounted between the Carousel Support Tower 232 and the Cylindrical Cam 230 is the Rotary Carousel 228, capped by the Rotary Carousel Cover 229. The Rotary Carousel 228 is configured to move vertically along the Carousel Support Tower 232. This vertical motion is directly imparted by the rotation of the Cylindrical Cam 230, whose external threads or grooves engage with corresponding Rotary Carousel Cam Pins 247 on the inner surface of the Rotary Carousel 228. The motion is guided by TCC guide slot pins 235 which ride within guide slots in the tower.

The TCC-to-Print-Head Mechanical Attachment 239 is also shown at the base of the assembly, providing the means to mechanically couple the TCC 220 to the Print Head during a tool change operation.

Housed within the Rotary Carousel 228 is the Flexible Interlocking Rack Gear 222 and its associated drive mechanism. As shown in the cross-section of FIG. 23 and detailed in its accompanying description, the rotation of the Cylindrical Cam 230 is selectively transferred to the Flex-Rack Drive Pinion 226 to extend or retract the gripper (224, illustrated in FIGS. 24b-26).

At the base of the Cylindrical Cam 230 are Cylindrical Cam drive gears 227, which serve as the input to rotate the cam.

FIG. 23 provides a cross-sectional perspective view of the TCC 220, taken along line 23-23 of FIG. 20. This view offers a detailed look at the internal mechanism of the Rotary Carousel 228.

Visible within the Rotary Carousel 228 is the Flexible Interlocking Rack Gear 222, shown in its fully retracted and coiled configuration wrapping around the central Cylindrical Cam 230. The teeth 264 of the rack gear 222 are engaged by the Flex-Rack Drive Pinion 226. The rotation of this pinion 226 drives the linear extension and retraction of the rack gear. This rotational power is selectively transferred from the Cylindrical Cam 230 to the pinion, specifically, when the vertical movement of the Rotary Carousel 228 is constrained by its guide pins 235, the cam's continued rotation instead drives the Flex-Rack Drive Pinion 226, causing the Flexible Interlocking Rack Gear 222 to extend or retract the Gripper (224, illustrated in FIGS. 24b-26).

The end of the Flexible Interlocking Rack Gear 222 is connected to the Gripper core 225, which in turn is attached to the gripper arms 249a,b. This assembly forms the extendable arm that grasps and releases Tool Holders.

The entire Rotary Carousel 228 is mounted coaxially, positioned between the stationary Carousel Support Tower 232 and the central Cylindrical Cam 230. Also shown is the TCC-to-Print-Head attachment arm 237, which is part of the mechanical linkage that connects the TCC 220 to the Print Head during a tool change operation.

FIGS. 24a, 24b, and 24c are detailed cross-sectional views, taken along line 24-24 of FIG. 21. FIGS. 24b, and 24c illustrate the constituent components of the gripper assembly 224 (or “gripper 224”) housed within the TCC 220. The views correspond to the cross-section indicated by line 24-24 in FIG. 21, which details the internal structure of the TCC 220 first introduced in FIG. 20. FIG. 24a shows a cross-section of the empty Rotary Carousel 228 housing, highlighting its internal geometry. FIG. 24b provides an isolated view of the core internal rack and pinion mechanism itself, showing it in its coiled, retracted state.

Specifically, FIG. 24a provides a cross-sectional view of the Rotary Carousel 228, shown empty to reveal its internal features. This view highlights the TCC guide slot pins 235, which protrude from the carousel's exterior to engage with the guide slots of the Carousel Support Tower 232. Also visible are the internal Rotary Carousel Cam pins 247, which are configured to interface with the helical grooves of the Multi-function Cylindrical Cam (not shown) to drive the carousel's vertical motion.

FIG. 24b depicts the core internal mechanism in isolation, illustrating the Flexible Interlocking Rack Gear 222 in its coiled, retracted state. The teeth 264 of the rack gear 222 are shown engaged with the Flex-Rack Drive Pinion 226. The pinion 226 includes Flex-Rack drive pinion cylindrical cam pins 241 that engage with internal features of the cylindrical cam (not shown) to receive rotational input. The Gripper 224 and its associated Gripper core 225 and gripper arms 249a,b are shown connected to the end of the rack gear. Notably, this view corresponds to the state where the Gripper Core Tang 244 (or “Flex-Rack gripper core tang 244”) is engaged with the release detent 242 located within the end of the Flexible Interlocking Rack Gear 222, securely locking the gripper 224 in its open (released) position. This view clarifies the structural relationship of the components that are housed within the Rotary Carousel 228 shown in FIG. 24a.

Building upon the state shown in FIG. 24b, FIG. 24c provides a perspective cross-sectional view of the mechanism fully extended and physically engaged with a Tool Holder 150. This view illustrates the state of the assembly during transport, for example, after it has been retrieved from a Tool Dock 204 but before it is loaded into the Print Head 110. The Flex-Rack Drive Pinion 226 has driven the Flexible Interlocking Rack Gear 222 to its full linear extension. The Gripper 224, located at the distal end of the extended rack gear 222, is shown securely grasping the Aluminum Clamping Section 166 of the Tool Holder 150. This engagement ensures a rigid and stable hold on the tool holder 150 during movement.

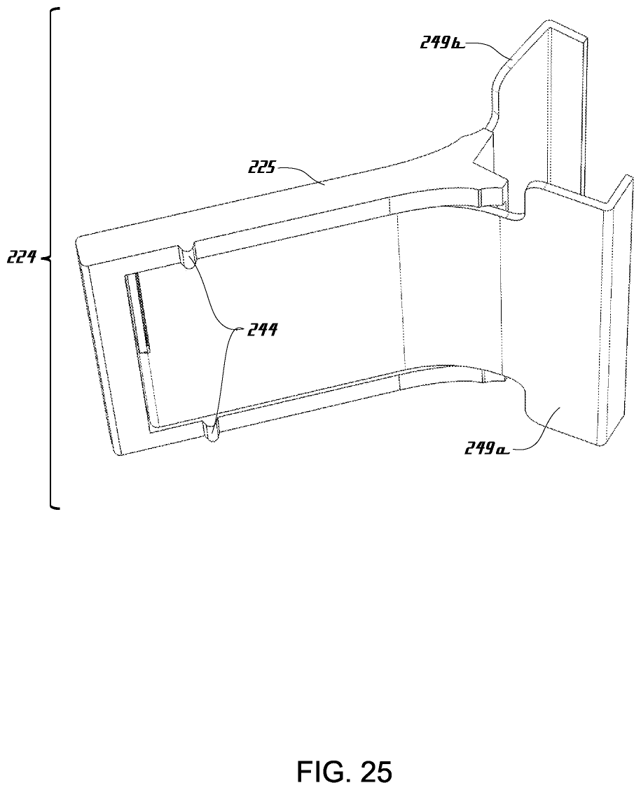

FIG. 25 provides an isolated perspective view of the gripper assembly 224. This assembly serves as the end-effector of the TCC, responsible for physically engaging and disengaging with Tool Holders. The gripper assembly 224 is depicted as a clasping mechanism. However, other end-effectors for engaging the tool holder are also envisioned, such as magnetic grippers or multi-fingered grasping mechanisms.

The Gripper assembly 224 comprises a central Gripper core 225 and two opposing gripper arms 249, shown here in their assembled state where the Gripper core 225 is fitted within the gripper arms 249. The Gripper core 225 is the component that attaches to the distal end of the Flexible Interlocking Rack Gear.

The Gripper core 225 includes at least one Flex-Rack gripper core tang 244. These tangs 244 are the features that engage with corresponding detents 242, 243 in the end of the Flexible Interlocking Rack Gear 222 to create a secure lock when grasping the tool, and may release the tool when the rack is retracted. When the Gripper 224 is fully clasped around a tool, the tangs 244 are held in position by the flex-rack gripper core tang in lock detent 243, creating a secure lock for tool transport. Conversely, when the Flexible Interlocking Rack Gear 222 is retracted after depositing a tool in the Print Head 110 or in its associated Dock 204, this retraction first pulls the Flexible Interlocking Rack Gear 222 back while the core tangs 244 slide out of detent 243 and deposit into detent 242, allowing the relaxation and release of the gripper 224 from the Tool Holder 150.

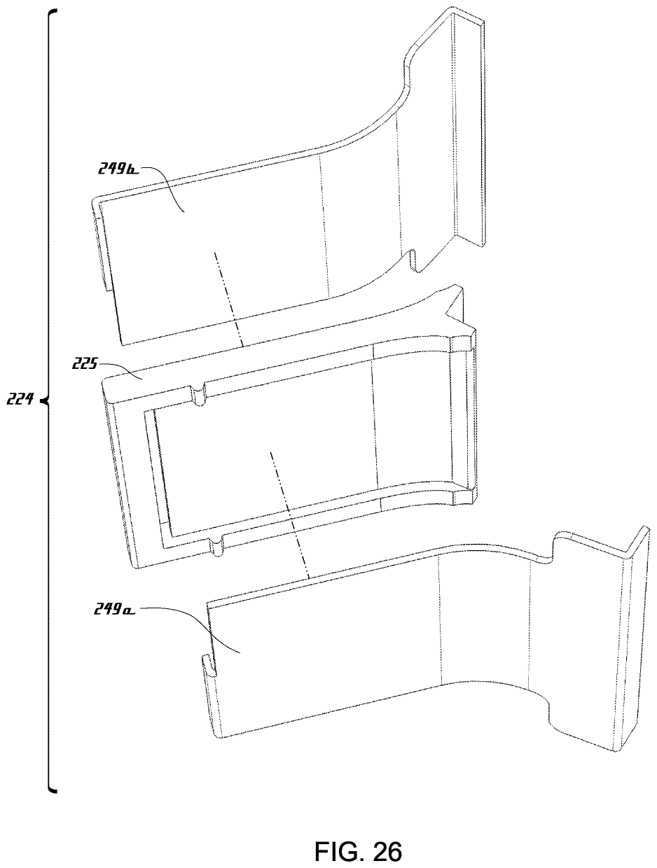

FIG. 26 provides an exploded perspective view of the gripper assembly 224, illustrating its constituent components. This view shows how the assembly 224 is constructed.

The assembly 224 comprises a central Gripper core 225 and two separate, opposing gripper arms 249 that form the Gripper assembly 224. In assembly, the Gripper core 225 is nested between the two gripper arms 249a,b. When joined, these components form the complete end-effector that is attached to the Flexible Interlocking Rack Gear and is responsible for securely grasping and releasing Tool Holders.

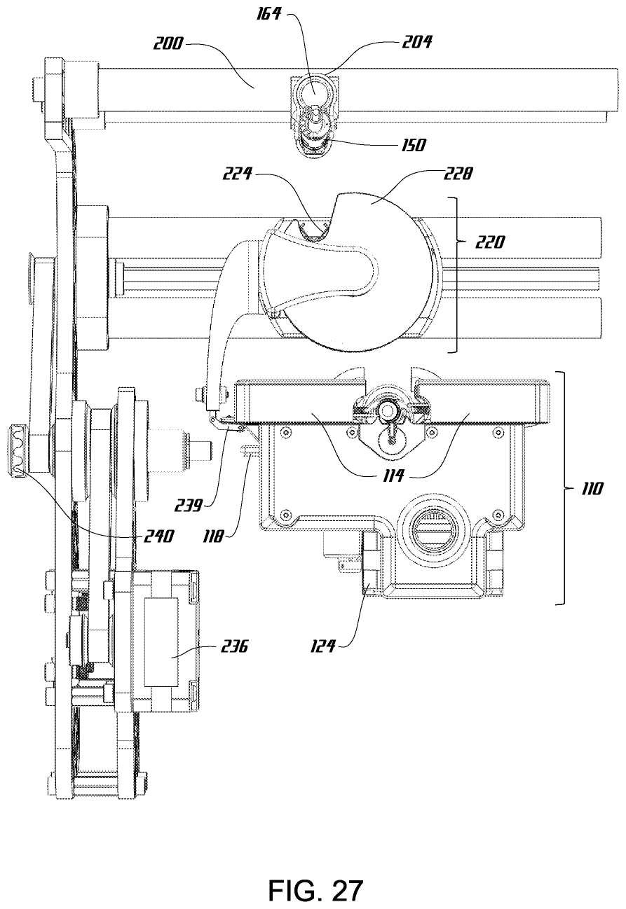

Referring now to FIGS. 27 through 38, a sequence of views illustrates the first half of the complete, automated tool change cycle performed by the system 100. These figures depict the coordinated mechanical interactions between the Print Head 110, the Tool Changer Carriage (TCC) 220, and the Tool Changing Transmission 248 as they execute the steps to retrieve a Tool Holder 150 from storage, load it into the Print Head, and clamp it for operation. The second half of the cycle, which includes the steps to release, unload, and store the Tool Holder, is not explicitly shown as these steps comprise essentially the same mechanical actions performed in reverse order.

FIG. 27 shows a top-down view of the tool-changing system in an initial state, such as at the beginning of a print job or prior to selecting a new tool. In this state, the system is prepared to retrieve a Tool Holder 150 from its docked position.

The Print Head assembly 110 and the TCC 220, are shown coupled via the TCC-to-Print-Head Mechanical Attachment 239 and are positioned along the x-axis to align the TCC 220 with a specific Tool Dock 204 mounted on the Docking Beam 200. The Tool Dock 204 is shown holding an inactive Tool Holder 150, with its Conical alignment and indexing Mounting Feature 164 visible.

The Print Head's Articulating Clamp Arms 114 are in a fully open position, and the Print Head 110 itself is unloaded, containing no Tool Holder. The Rotary Carousel 228 of the TCC 220 is oriented to face the Docking Beam 200, with its Gripper 224 retracted and ready to be extended.

The system's drive mechanism is configured for a tool change operation. The Tool Change Stepper Motor 236 is the active “E” stepper motor, receiving drive signals from the printer's controller. The Tool Changing Transmission is disengaged from the Print Head's clamping mechanism, allowing the motor's output to drive the tool change functions of the TCC 220.

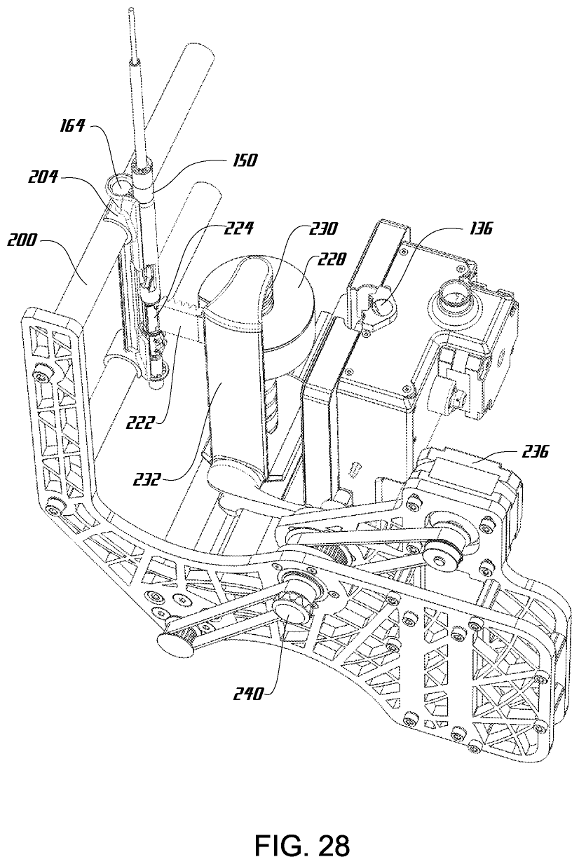

FIG. 28 provides a perspective view illustrating the next step in the tool loading sequence, which follows the initial state shown in FIG. 27. This figure depicts the action of grasping a new docked Tool Holder 150.

This action is initiated by the clockwise rotation of the multi-function Cylindrical Cam 230, which is driven by the Tool Change Stepper Motor 236. At this specific vertical elevation, the Rotary Carousel 228 is constrained from vertical movement by its guide pins within the guide slots of the Carousel Support Tower 232.

Consequently, the rotation of the Cylindrical Cam 230 is transferred to the Flex-Rack Drive Pinion, causing it to rotate. The rotation of the pinion drives the Flexible Interlocking Rack Gear 222 linearly outward from the Rotary Carousel 228. This linear extension moves the attached Gripper 224 horizontally toward the Docking Beam 200, causing the Gripper 224 to engage and lock onto the clamping section of the docked Tool Holder 150, which is held in the Tool Dock 204. The Conical alignment and indexing Mounting Feature 164 of the Tool Holder 150 is also visible.

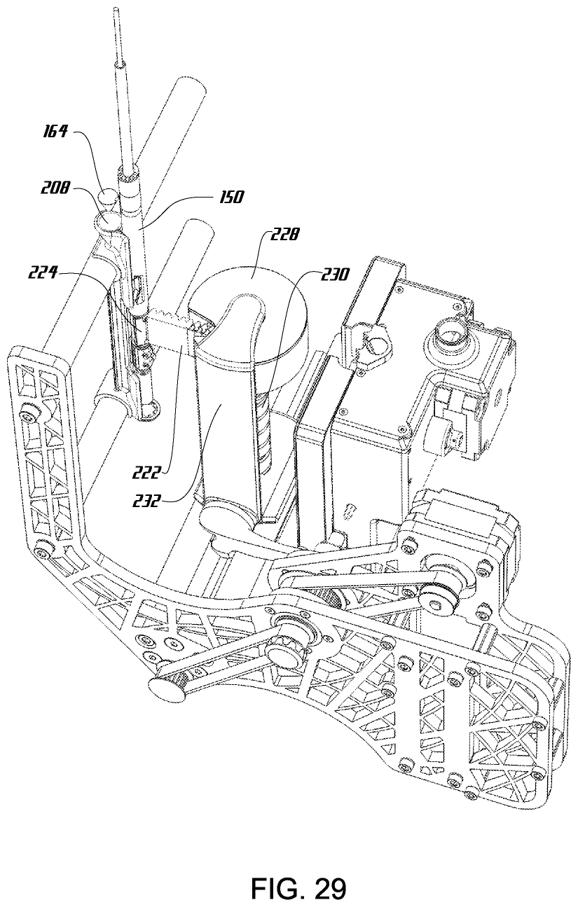

Following the grasping action shown in FIG. 28, FIG. 29 illustrates the subsequent step in the loading sequence, wherein the Tool Holder 150 is lifted out of its Tool Dock 204.

This lifting motion is achieved by the continued clockwise rotation of the multi-function Cylindrical Cam 230. At this phase of the cycle, the cam's 230 rotation is translated into vertical movement of the Rotary Carousel 228. As the Rotary Carousel 228 rises along the Carousel Support Tower 232, it carries the attached Tool Holder 150 with it, moving it vertically up and away from the Tool Dock 204.

The figure depicts the completion of this step, with the Tool Holder 150 now positioned at an elevated height, clear of the docking system and ready for the next motion in the tool change sequence. The gripper 224 remains extended, securely holding the Tool Holder 150.

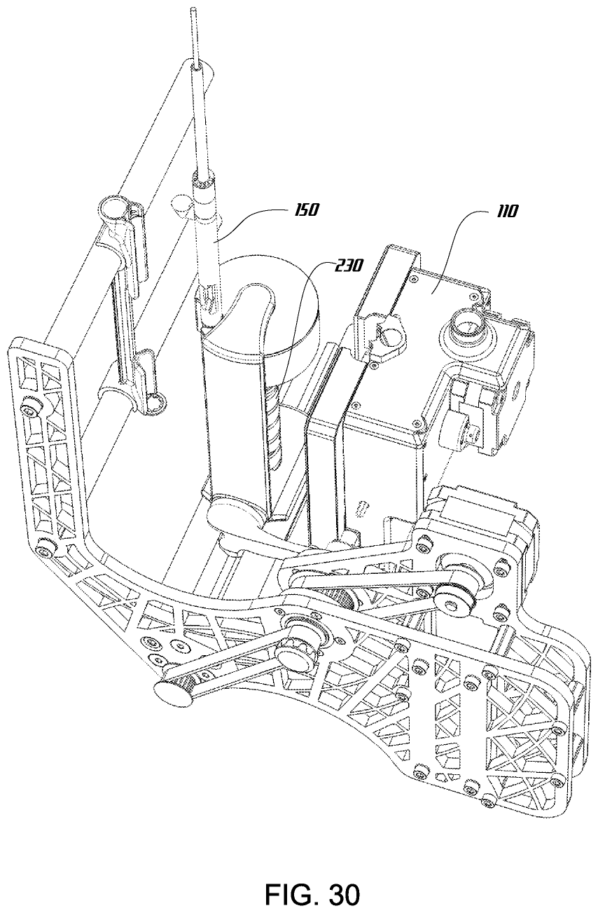

FIG. 30 shows a perspective view of the next step in the loading sequence, following the lifting of the Tool Holder 150 as depicted in FIG. 29. This figure illustrates the retraction of the grasped Tool Holder 150 into the Rotary Carousel 228.

This retraction motion is initiated by the counter-clockwise rotation of the multi-function Cylindrical Cam 230. At this specific vertical elevation, the Rotary Carousel 228 is constrained from vertical movement by its guide pins within the guide slots of the Carousel Support Tower. This causes the cam's 230 rotation to be transferred to the Flex-Rack Drive Pinion.

The rotation of the pinion retracts the Flexible Interlocking Rack Gear, pulling it and the attached gripper assembly horizontally into the Rotary Carousel 228. As the gripper assembly retracts, it brings the Tool Holder 150 with it. The figure shows the completion of this step, with the Tool Holder 150 now fully retracted and housed within the Rotary Carousel 228, ready for the next stage of the tool change process.

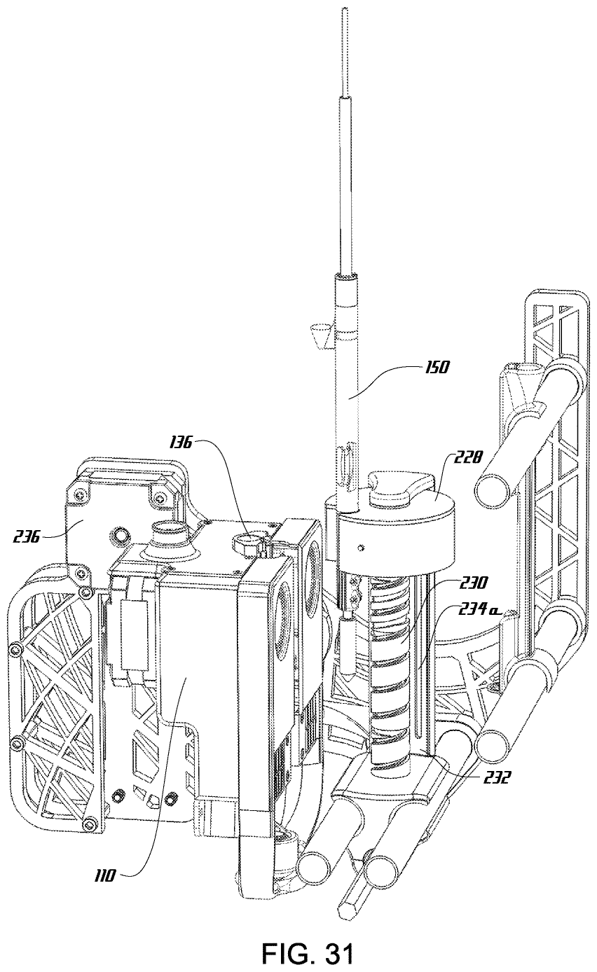

FIG. 31 provides a perspective view of the TCC 220 assembly executing the next step in the loading sequence, following the retraction of the Tool Holder shown in FIG. 30. This figure illustrates the 180-degree rotation of the Rotary Carousel 228 from its initial ‘dockside’ orientation, where it faces the docking system, to its ‘printside’ orientation, where it now faces the Print Head assembly 110.

The Tool Holder 150 remains fully retracted within the Rotary Carousel 228 during this rotational movement. This motion is induced by the clockwise rotation of the multi-function Cylindrical Cam 230, which is driven by the Tool Change Stepper Motor 236.

As the Rotary Carousel 228 is moved vertically by the cam 230, its guide pins 235 disengage from one set of vertical guide slots 234 in the Carousel Support Tower 232 and engage with another set, compelling the entire Rotary Carousel 228 to rotate 180 degrees. Upon completion of this step, the Tool Holder 150 is positioned to be lowered into extension position to align with the Conical alignment and indexing receptacle 136 of the Print Head 110.

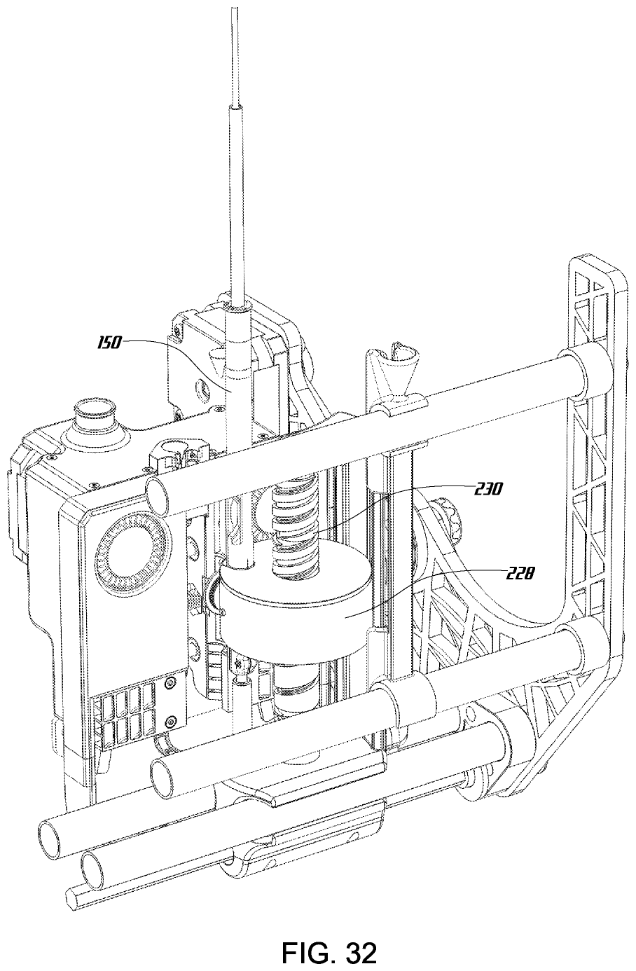

FIG. 32 provides a perspective view of the TCC 220 assembly executing the next step in the loading sequence, following the rotation shown in FIG. 31. This figure illustrates the lowering of the Rotary Carousel 228, which carries the retracted Tool Holder 150.

This vertical downward motion is initiated by the counter-clockwise rotation of the multi-function Cylindrical Cam 230. The rotation of the cam 230 causes the Rotary Carousel 228 to translate vertically downwards along the Carousel Support Tower.

The purpose of this step is to position the Rotary Carousel 228 and the contained Tool Holder 150 at a specific vertical position known as the “extension height.” This pre-determined height aligns the Tool Holder 150 for the subsequent step of being extended horizontally towards the Print Head for loading.

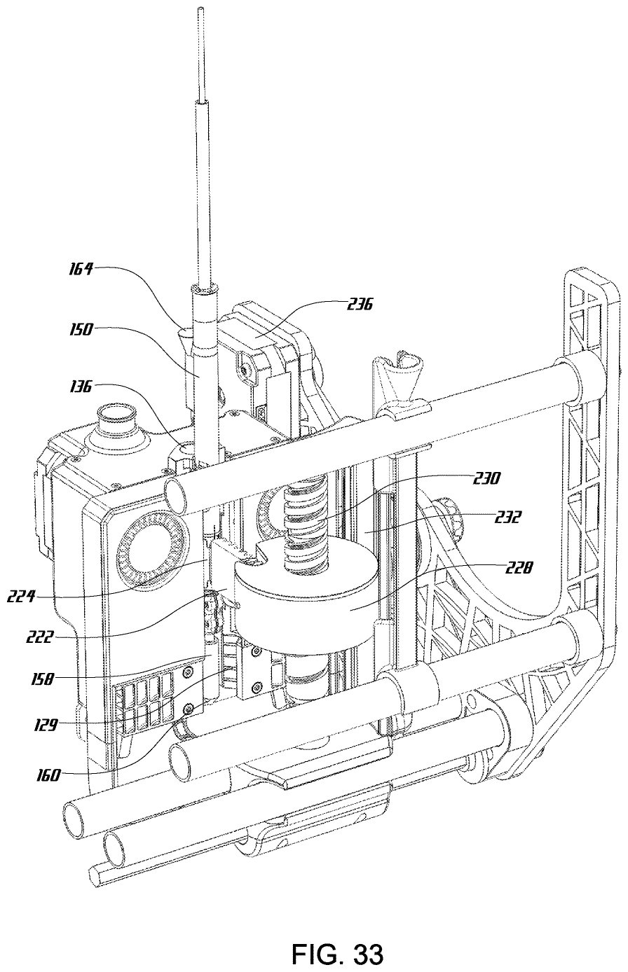

FIG. 33 shows a perspective view of the TCC 220 assembly executing the next step in the loading sequence, following the lowering of the assembly to the extension height as shown in FIG. 32. This figure illustrates the horizontal extension of the Tool Holder 150 into the loading position of the Print Head.

This extension motion is initiated by the clockwise rotation of the multi-function Cylindrical Cam 230, driven by the Tool Change Stepper Motor 236. At this specific vertical elevation, the Rotary Carousel 228 is constrained from vertical motion by its guide pins in the guide slots 234 of the Carousel Support Tower 232.

With the vertical motion constrained, pins in the Flex-Rack Drive Pinion lock to the Cylindrical Cam 230, causing the pinion to rotate with the cam 230. This pinion rotation directly drives the Flexible Interlocking Rack Gear 222, extending it and the held Tool Holder 150 into the Print Head load position. This action pushes the attached gripper 224 and the held Tool Holder 150 horizontally toward the Print Head.

The figure shows the completion of this step, with the Conical alignment and indexing Mounting Feature 164 of the Tool Holder 150 positioned for engagement with the Conical alignment and indexing receptacle 136 of the Print Head. The Hot End of Nozzle 158 and Nozzle Tip 160 are simultaneously guided into the heater element of the Print Head.

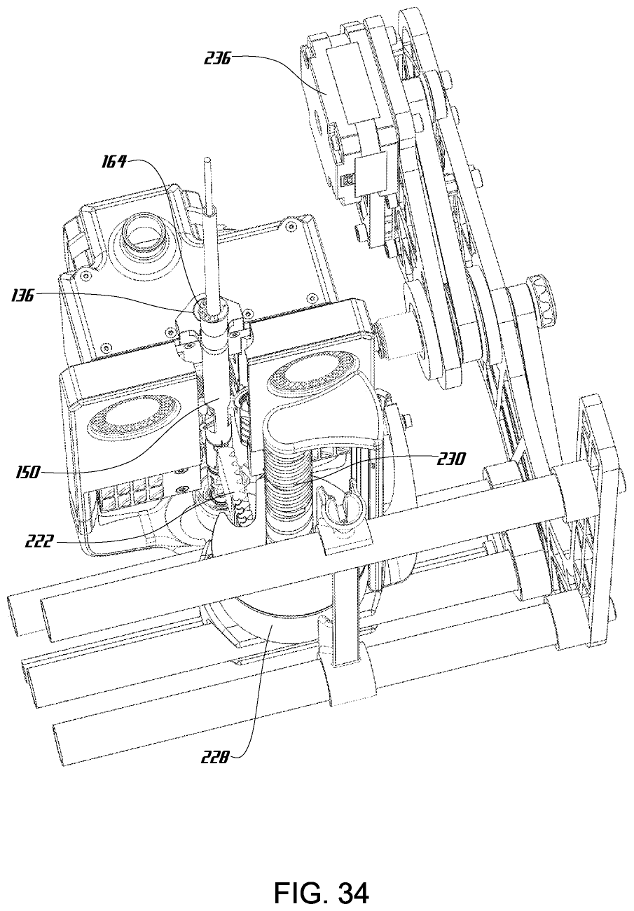

FIG. 34 provides a perspective view of the final step in the physical loading of the Tool Holder 150 into the Print Head 110. Following the horizontal extension shown in FIG. 33, this figure illustrates the action of lowering the Rotary Carousel 228 to its loaded height and thereby loading the Tool Holder 150 into the Print Head.

This final seating motion is achieved as the multi-function Cylindrical Cam 230 is rotated counter-clockwise, causing the vertical lowering of the Rotary Carousel 228 and the fully extended Tool Holder 150 into the Print Head. As the Rotary Carousel 228 descends, the Tool Holder 150 is fully seated within the Print Head assembly.

The Conical alignment and indexing Mounting Feature 164 of the Tool Holder 150 engages with the corresponding Conical alignment and indexing receptacle 136 on the Print Head, ensuring precise and repeatable positioning. Simultaneously, the Hot End of Nozzle 158 is fully inserted into the heater element of the Print Head. At the completion of this step, the Tool Holder 150 is precisely positioned and ready for the subsequent clamping and disengagement sequence.

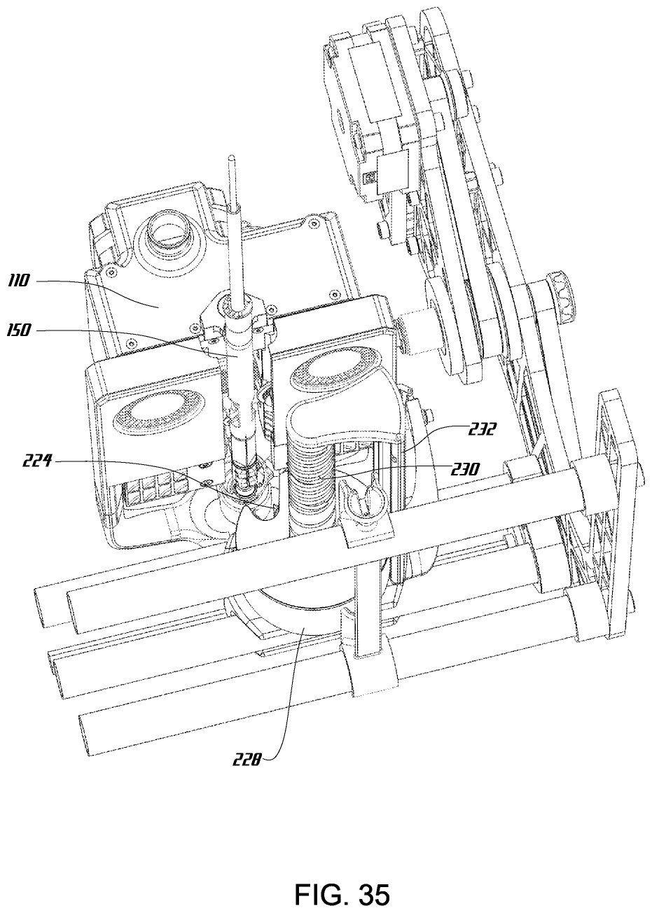

FIG. 35 provides a perspective view of the TCC 220 assembly executing the next action in the loading sequence, following the seating of the Tool Holder as shown in FIG. 34. This figure illustrates the process of retracting the Flexible Interlocking Rack Gear 222 into the Rotary Carousel 228, thereby disengaging from the loaded Tool Holder 150 in the Print Head 110.

This retraction is achieved as the multi-function Cylindrical Cam 230 continues to rotate counter-clockwise. At this specific vertical elevation, the Rotary Carousel 228 is constrained from vertical motion by its guide pins in the guide slots of the Carousel Support Tower 232.

With the vertical motion constrained, pins in the Flex-Rack Drive Pinion lock to the Cylindrical Cam 230, causing the pinion to rotate with it. This pinion rotation retracts the Flexible Interlocking Rack Gear 222 and the Gripper 224 back into the body of the Rotary Carousel 228. As the Gripper 224 retracts, it disconnects from the loaded Tool Holder 150, leaving the Tool Holder 150 seated within the Print Head 150, ready to be clamped.

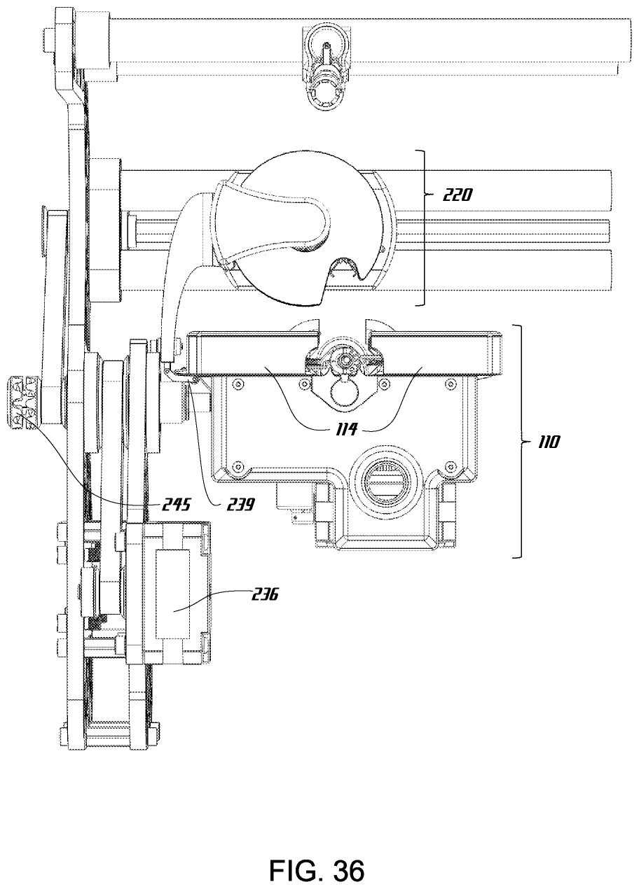

FIG. 36 shows a top-down view of the system in a post-load state, preparing for clamping the loaded Tool Holder 150. Following the loading sequence shown in FIGS. 27-35, the Print Head 110 and TCC 220 remain connected and have moved together along the X-axis to engage with the clamp-driving end of the Tool Changing Transmission 248.

In this configuration, the Print Head 110 is now loaded with the new Tool Holder 150, while the clamping arms 114 of the Print Head 110 remain open. Crucially, the Print Head 110 is coupled to the Tool Changing Transmission 248 for the upcoming clamp/un-clamp operation. This coupling disengages the disengaged TCC Clutch Assembly 245, which redirects the rotational output of the Tool Change Stepper Motor 236 to now drive only the clamping arms 114 of the Print Head 110, while decoupling the motor's output from the TCC's 220 drive system.

The TCC 220 remains connected to the Print Head 110, with its Rotary Carousel 228 and Gripper 224 facing the Print Head 110 and the Flexible Interlocking Rack Gear 222 fully retracted within the Rotary Carousel 228. The system is now staged to execute the clamping of the Tool Holder 150.

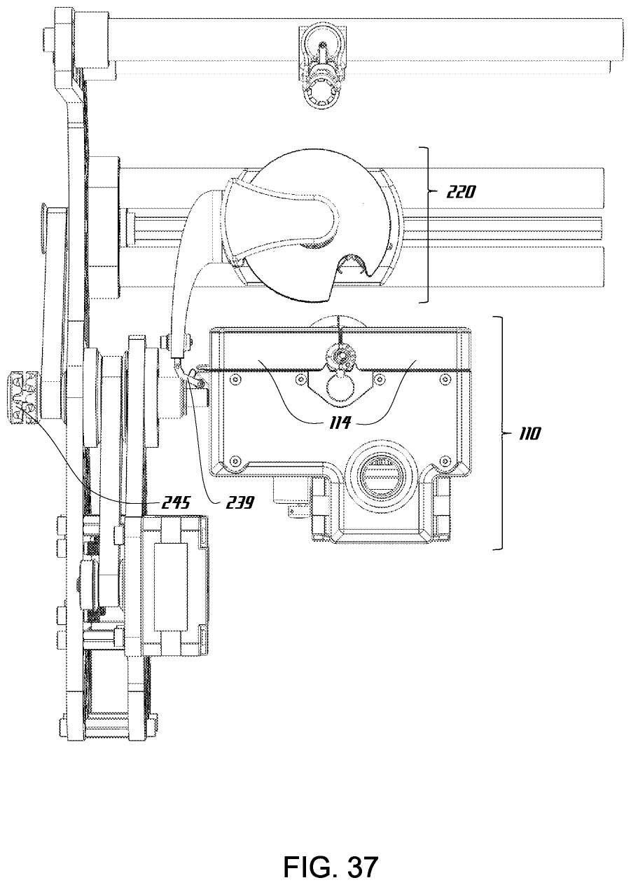

FIG. 37 shows a top-down view of the system executing the clamping and disconnection phase, which follows the staging shown in FIG. 36. This figure illustrates the process of clamping the new Tool Holder 150 into the Print Head 110 and simultaneously disconnecting the Print Head 110 from the TCC 220.

This action is achieved as the Tool Change Stepper Motor 236 drives the Tool Changing Transmission 248. With the transmission 248 configured to operate the clamping arms 114, the Dual-Threaded Clamping Screw 116 is rotated clockwise. This rotation draws the Articulating Clamp Arms 114 inward, securely clamping the Tool Holder 150 into its operational position within the Print Head 110.

The inward motion of the clamping jaws 114 also actuates the disconnection of the TCC 220 from the Print Head 110. As the clamping arms 114 close, the TCC-to-Print-Head Mechanical Attachment 239 disengages from the Print Head 110. The result of this integrated action is that the clamping motion disconnects the TCC 220 from the Print Head 110, leaving the TCC 220 parked at its max-X position. With the Tool Holder 150 now securely clamped via the clamping arms 114 and the TCC 220 disconnected, the Print Head 110 is free to move away from the max-X position to begin its operational tasks.

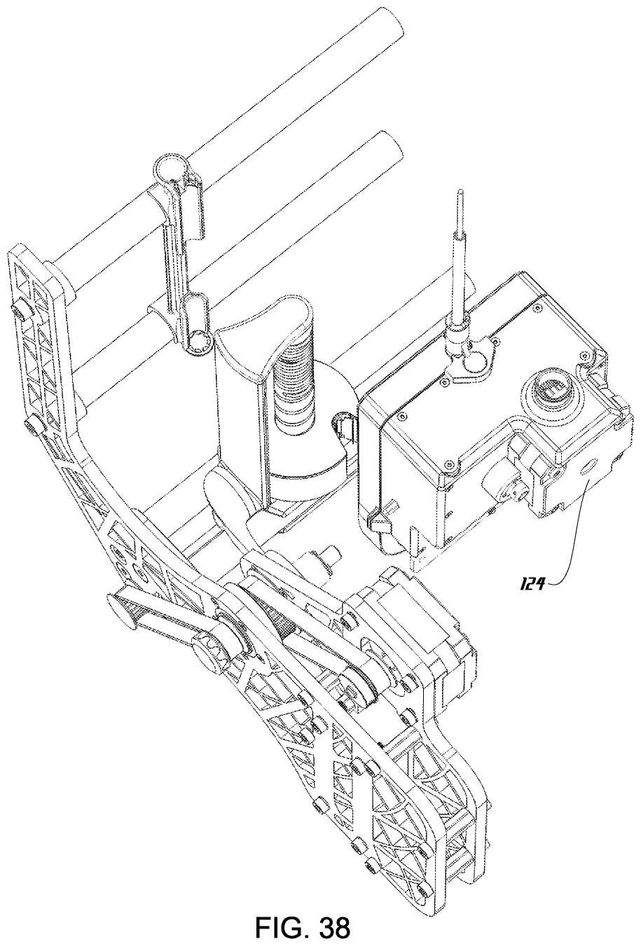

FIG. 38 provides a perspective view of the system after the completion of the tool change cycle, building on the clamping and disconnection shown in FIG. 37. This figure illustrates the Print Head operating independently with the newly loaded Tool Holder 150.

The primary action shown is the disconnection of the Print Head from the Tool Changing Transmission 248. After the clamping operation is complete, the Print Head assembly physically moves away from the max-X position, leaving the TCC parked. This movement pulls the clamping drive shaft out of the Tool Changing Transmission 248, causing its internal clutch to revert to its default, spring-loaded state.

This mechanical reversion switches the system's “E” axis control from the Tool Change Stepper Motor 236 back to the Print Head's onboard Extruder Stepper Motor 124. With its own motor now active, the Print Head starts operating with the new tool holder, fully independent and ready to perform its designated task, such as extruding filament, while moving freely along the gantry.

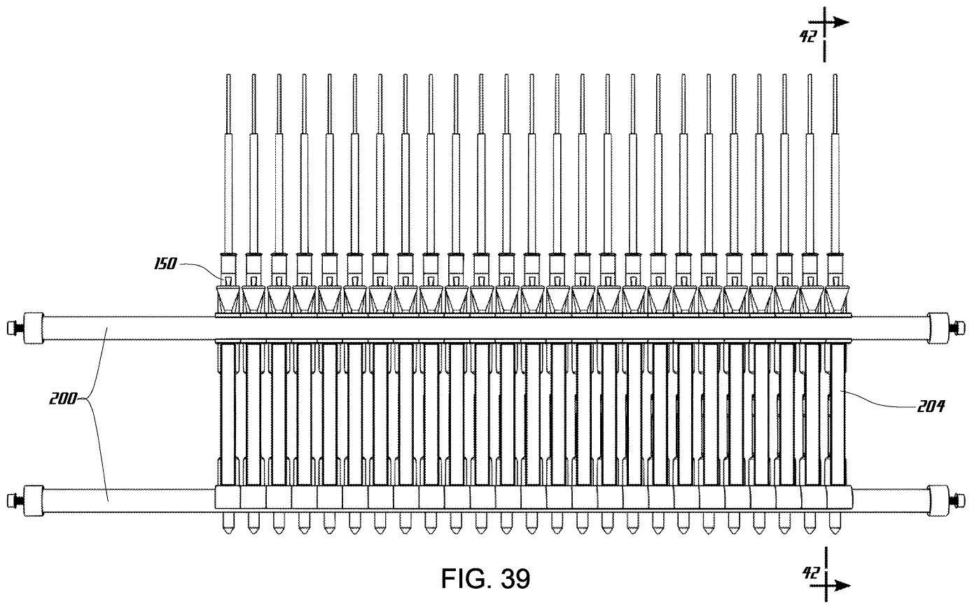

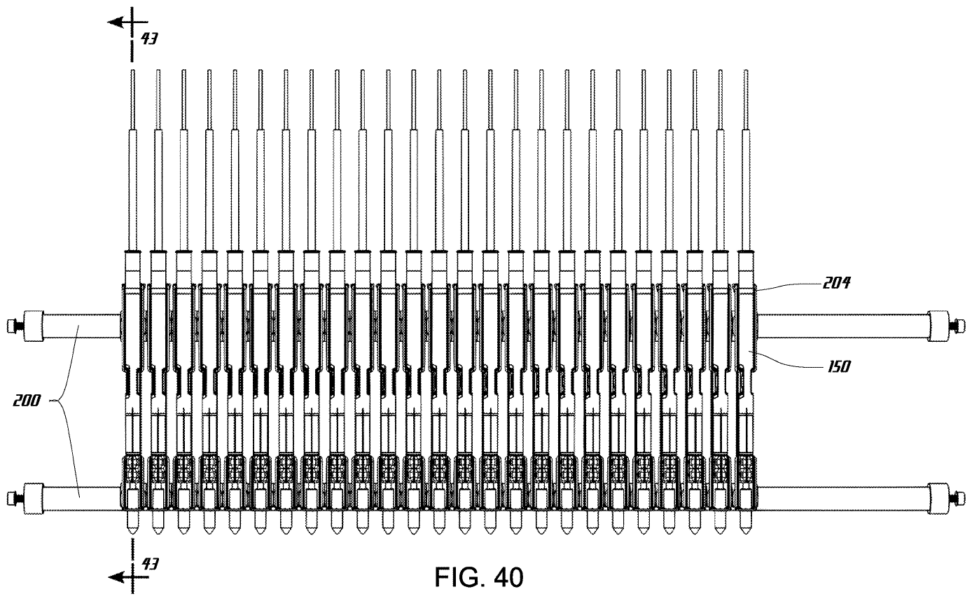

FIG. 39 provides a front elevation view of the complete tool docking system assembly, while FIG. 40 provides a rear elevation view of the same assembly. Together, these figures illustrate the storage component of the modular tool-changing system.

The assembly comprises a primary structural rail, the Docking Beam 200, which is mounted parallel to the X-axis gantry of the host 3D printer. A plurality of Tool Docks 204 are mounted at regular, known intervals along the length of the Docking Beam 200.

Each Tool Dock 204 is configured to receive and securely store one Tool Holder 150 when it is not in use by the Print Head. The figures show a fully populated docking system with multiple Tool Holders 150 seated in their respective Tool Docks 204.

Together, these components provide a stationary and precisely located storage rack from which the Tool Changer Carriage can retrieve, and to which it can return, various Tool Holders during the automated tool change process as illustrated in FIGS. 27-38. This arrangement of Tool Docks 204 and their associated inactive Tool Holders 150 allows the system to access a specific tool by moving to its known X-axis coordinate.

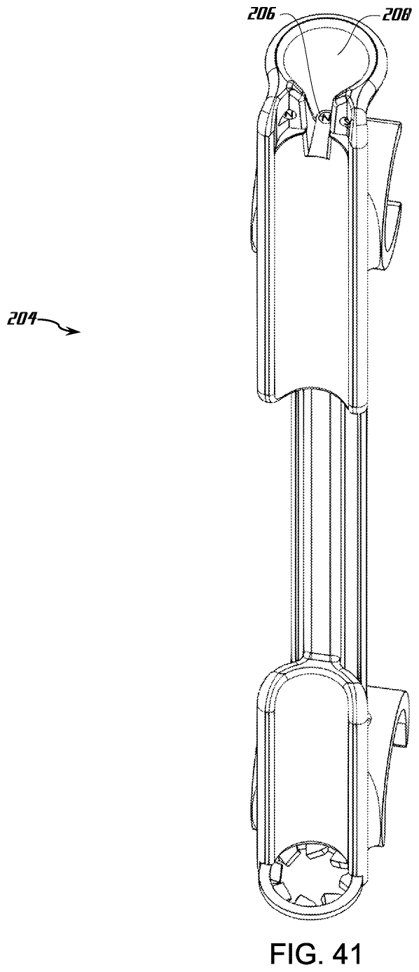

FIG. 41 presents a perspective view of an individual Tool Dock 204. This figure illustrates the features within the dock that are responsible for securely storing a Tool Holder.

The Tool Dock 204 is a passive component designed to securely hold a Tool Holder 150 when it is not in use. The upper opening of the Tool Dock 204 is defined by a conical receptacle 208. This receptacle is functionally and geometrically identical to the Conical alignment and indexing receptacle 136 located in the Print Head 110. This shared mounting geometry is a key design feature that ensures a Tool Holder 150 is seated with the same precise and repeatable positioning whether stored in the dock or loaded for operation in the Print Head, providing consistent alignment throughout the system.

Positioned within the main body of the Tool Dock 204 is a Tool Dock Alignment Magnet 206. This magnet serves to attract a corresponding magnet or ferromagnetic feature on the Tool Holder, pulling the Tool Holder into its correct and final seated position. This magnetic attraction ensures precise alignment and securely retains the Tool Holder within the Tool Dock 204, preventing unwanted movement.

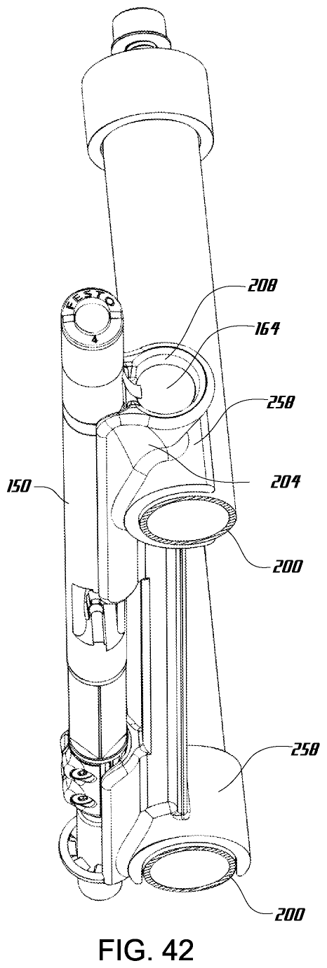

FIG. 42 provides a cross-sectional view taken along line 42-42 of FIG. 39, illustrating the interaction between a Tool Holder 150 and a Tool Dock 204. The Tool Dock 204 is shown removably mounted on the Docking Beam 200 via fasteners 258.

The Conical alignment and indexing Mounting Feature 164 of the Tool Holder 150 is shown aligned with the upper opening of the Tool Dock 204. The Tool Holder Hangers 208, forming the conical receptacle of the Tool Dock 204, are positioned to receive and mate with the Conical alignment and indexing Mounting Feature 164. Due to the identical geometry shared with the Print Head's receptacle 136, when the Tool Holder 150 is fully seated, the hangers 208 provide precise vertical and rotational support, suspending the tool securely within the dock.

FIG. 43 presents a cross-sectional view, taken along line 43-43 of FIG. 40, illustrating a Tool Holder 150 fully seated and stored within a Tool Dock 204.

This view shows the physical relationship between a stored Tool Holder 150 and its corresponding Tool Dock 204. The Tool Dock 204 is removably mounted on the Docking Beam 200 via fastener 258. The internal profile of the Tool Dock 204 is shaped to conform to the external profile of the Tool Holder 150, providing a secure and stable resting position.

The cross-section reveals several internal features of the Tool Holder 150, including the Extruder Wheel Access Slots 168, the Aluminum Nozzle Chuck 162 which secures the nozzle assembly, and the Hot End of Nozzle 158. This orientation represents the inactive or stored state of a tool, where it is held securely on the docking system, ready for retrieval by the Tool Changer Carriage during the automated tool-changing process.

Referring now to FIGS. 44-47, the system's function multiplexing is orchestrated by the Tool Changing Transmission. This assembly serves as the central clutch mechanism that selectively directs the output of the single Tool Change Stepper Motor to one of two different mechanical functions based on the physical position of the Print Head.

FIG. 44 provides a perspective view of the Tool Changing Transmission 248 in its default, spring-loaded state, and FIG. 45 provides a cross-sectional view of the same assembly, taken along line 45-45 of FIG. 44. This transmission 248 serves as the central clutch mechanism that selectively directs the output of a single motor to one of two different mechanical functions.

As depicted in FIGS. 44 and 45, the transmission's 248 default, spring-loaded state corresponds to the engaged TCC Clutch Assembly 240. In this state, the internal face clutch is engaged by the force of the Clutch engagement spring 294. The spring 294 is housed within the Clutch engagement spring cannister 295, which is secured by a circlip 296, and it exerts axial force on the Clutch Spline Shaft 298. This force presses the Clutch plate on toolchange driving pulley 292 firmly against the main Clutch 290, thus engaging the face clutch. This engagement ensures that rotational power from the Tool Change Stepper Motor 236 is transferred to the drive system for the TCC's 220 robotics (i.e., the Multi-function Cylindrical Cam 230). This state is active whenever the Print Head 110 is not physically engaged with the transmission for a clamping or unclamping operation.

Conversely, when the tool holder clamp drive socket 246 is pushed fully into the transmission 248, it physically disengages the face clutch, decoupling the motor from the TCC's drive system and simultaneously engaging the drive for the Print Head's clamping mechanism. This dual-function clutch enables a single motor to control both the complex motions of the Tool Changer Carriage and the clamping/unclamping of the Tool Holder.

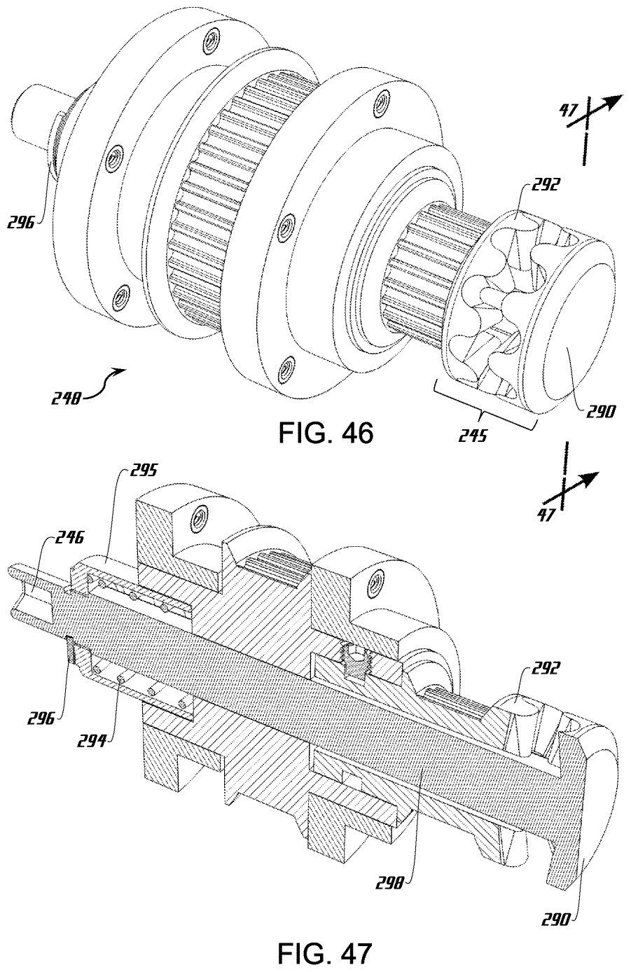

FIG. 46 provides a perspective view of the Tool Changing Transmission 248 in its actuated or disengaged state, and FIG. 47 provides a cross-sectional view of the same assembly, taken along line 47-47 of FIG. 46. These figures illustrate the transmission 248 in its second operational state, which corresponds to the disengaged TCC Clutch Assembly 245.

Referring to FIGS. 46 and 47, the transmission 248 enters its second operational state, corresponding to the disengaged TCC Clutch Assembly 245, when a clamping or unclamping operation is required. To achieve this, the Print Head 110 moves to its maximum X-axis position, causing the Clamping Screw Drive Engagement Feature 118 on the Print Head to fully insert into and engage the tool holder clamp drive socket 246 of the transmission 248. This full insertion causes the engagement feature 118 to physically push against the Clutch Spline Shaft 298. This axial movement compresses the Clutch engagement spring 294 and pulls the Clutch plate 292 away from the main Clutch 290, thereby disengaging the internal face clutch. In this disengaged state, rotational power from the Tool Change Stepper Motor 236 is decoupled from the TCC's 220 robotic drive system. Instead, the motor's power is now directly coupled to the tool holder clamp drive socket 246, allowing the motor to drive the Dual-Threaded Clamping Screw 116 of the Print Head assembly. This dual-function clutch is a core component that enables a single motor to control both the complex motions of the Tool Changer Carriage and the clamping/unclamping of the Tool Holder.

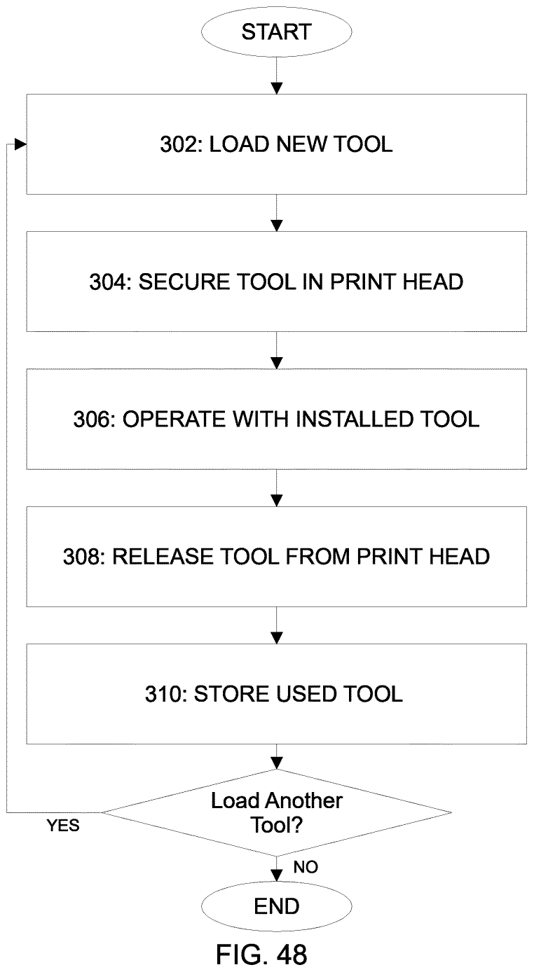

FIG. 48 is a flowchart diagram illustrating an exemplary sequence of operations for the automated tool-changing process 300 performed by the modular tool-changing system 100. The process 300 is broken down into a series of states and actions that enable the automated loading, securing, operating, releasing, and storing of a plurality of Tool Holders 150, thereby facilitating multi-tool and multi-material fabrication on a host 3D printer.

The process begins at a START state, which represents the initial conditions of the system 100 prior to a print job or before loading a new tool. In this state, the Print Head assembly 110 and the Tool Changer Carriage (TCC) 220 are mechanically attached, the Print Head's Articulating Clamp Arms 114 are in an open and empty condition, the host printer's extruder motor signal (the ‘E’ signal) is set to drive the Tool Change Stepper Motor 236 which is the active ‘E’ stepper motor. The TCC 220 is oriented to face the Docking Beam 200, with its Gripper 224 retracted and ready to be extended.

From the START state, the flow proceeds to step 302, “LOAD NEW TOOL.” In this step, the combined Print Head 110 and TCC 220 assembly moves along the X-axis to the location of a target Tool Dock 204 holding a desired Tool Holder 150. The TCC 220 then actuates its Flexible Interlocking Rack Gear 222 to extend the Gripper 224, which grasps the new Tool Holder 150. The TCC 220 then lifts the Tool Holder 150 vertically from its Tool Holder Hanger 208, retracts it fully into the Rotary Carousel 228, and rotates the carousel 180 degrees to orient the Tool Holder 150 toward the Print Head 110 and lowers vertically to Tool Holder 150 extension height. Finally, the Flexible Interlocking Rack Gear 222 extends and lowers the Tool Holder 150 into the Print Head's Conical Alignment Receptacle 136, after which the Gripper 224 retracts, leaving the tool seated in the Print Head.

Following the loading of the tool, the process continues to step 304, “SECURE TOOL IN PRINT HEAD.” In response to a GCODE command, the Print Head 110 moves to a predefined maximum X-axis position to engage its Clamping Screw Drive Engagement Feature 118 with the Tool Changing Transmission 248. This mechanical engagement actuates the transmission's internal clutch mechanism, which redirects the rotational output of the Tool Change Stepper Motor 236 to the print head's Dual-Threaded Clamping Screw 116. The subsequent rotation of the clamping screw drives the Articulating Clamp Arms 114 to close and securely fasten the Tool Holder 150. As an integrated part of this clamping motion, the TCC 220 is mechanically disengaged and parked. Upon the completion of this sequence and the disengagement from the TCC, the E/T Toggle Switch is tripped, toggling the primary motor signal from the Tool Change Stepper Motor 236 to the onboard Extruder Stepper Motor 124 for independent print operations.

At step 306, “OPERATE WITH INSTALLED TOOL,” the system is in its primary operational state. The Print Head 110, now decoupled from the TCC 220, is free to move about the build area and use the installed Tool Holder 150 to perform its designated function, such as extruding material, sensing, or milling. The host printer's GCODE commands for the ‘E’ axis now control the Extruder Stepper Motor 124 to operate the specific function of the installed tool.

Upon completion of the operation or when a new tool is required, the process moves to step 308, “RELEASE TOOL FROM PRINT HEAD.” This step mirrors the actions of step 304 in reverse. In response to a subsequent GCODE command, the Print Head 110, with its onboard Extruder Stepper Motor 124 active, returns to the maximum X-axis position to re-engage the Tool Changing Transmission 248. This mechanical re-engagement immediately trips the E/T Toggle Switch, toggling the motor signal from the Extruder Stepper Motor 124 back to the Tool Change Stepper Motor 236. With the correct motor now active, the transmission 248 then actuates the Dual-Threaded Clamping Screw 116 in the reverse direction, causing the Clamp Arms 114 to open and release the Tool Holder 150. This unclamping action simultaneously re-attaches the TCC 220 to the Print Head 110, preparing the system for the subsequent tool storage operation.

The process then proceeds to step 310, “STORE USED TOOL.” The combined Print Head 110 and TCC 220 assembly moves to the designated Tool Dock 204 for the used tool. The TCC 220 extends its Flex-Rack 222 to grasp the now-unclamped Tool Holder 150, lifts it from the Print Head 110, rotates it 180 degrees via the Rotary Carousel 228, and lowers it back onto the Tool Holder Hanger 208 within its dock, releasing it.

Finally, at the decision point “Load Another Tool?”, the system determines if another tool is required for the build process. If ‘YES’, the flow loops back to step 302 to begin the loading sequence for the next tool. If ‘NO’, the process terminates at the END state, with the last-used tool securely stored and the system idle. In further embodiments, the system may comprise modules or sensors for error recognition and handling, such as detecting a failure to grasp a tool, and may initiate a restart or alert process in such an event.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What I claim is:

1. A modular tool-changing system for an additive manufacturing machine, the system comprising:
a print head assembly comprising a clamping mechanism and a first receptacle;
at least one interchangeable tool holder;
a docking system comprising at least one tool dock, the at least one tool dock comprising a second receptacle for storing the at least one interchangeable tool holder; and
a tool changer carriage movable between the print head assembly and the at least one tool dock, the tool changer carriage comprising a gripper for transporting the at least one interchangeable tool holder between the first receptacle of the print head assembly and the second receptacle of the at least one tool dock.

2. The system of claim 1, wherein the clamping mechanism of the print head assembly comprises a pair of articulating clamp arms, each clamp arm comprising an integrated heatsink and a clamping surface, and wherein movement of the clamp arms to a closed position causes the clamping surfaces to make direct thermal contact with the at least one interchangeable tool holder.

3. The system of claim 2, wherein the print head assembly further comprises one or more fans positioned to direct airflow over the integrated heatsinks of the pair of articulating clamp arms.

4. The system of claim 1, wherein the tool changer carriage comprises a rotary carousel and a flexible interlocking rack gear housed within the rotary carousel, the flexible interlocking rack gear supporting the gripper at a distal end.

5. The system of claim 4, wherein the tool changer carriage further comprises a multi-function cylindrical cam, wherein rotation of the multi-function cylindrical cam selectively causes one of a vertical or rotary movement of the rotary carousel or a linear extension of the flexible interlocking rack gear.

6. The system of claim 1, further comprising a tool changing transmission mechanically coupled to a motor, wherein the tool changing transmission in a first state directs output from the motor to the tool changer carriage, and wherein the tool changing transmission in a second state directs output from the motor to the clamping mechanism of the print head assembly.

7. The system of claim 6, wherein the tool changing transmission is switched from the first state to the second state by a physical engagement with the print head assembly.

8. The system of claim 1, wherein the at least one interchangeable tool holder comprises a conical alignment feature, and wherein the first receptacle of the print head assembly and the second receptacle of the at least one tool dock each comprise a corresponding conical geometry for mating with the conical alignment feature.

9. The system of claim 8, wherein the print head assembly further comprises a tool holder alignment magnet positioned within the first receptacle to magnetically retain the at least one interchangeable tool holder.

10. A print head assembly for an automated tool-changing system, the assembly comprising:
a main body defining a receptacle for receiving an interchangeable tool holder;
a pair of articulating clamp arms, each clamp arm comprising an integrated heatsink and a clamping surface;
at least one clamping actuator operatively coupled to the pair of articulating clamp arms to move the clamp arms between an open position and a closed position, wherein in the closed position the clamping surfaces make direct thermal contact with an interchangeable tool holder seated in the receptacle; and
an extrusion drive mechanism comprising a set of drive wheels, wherein movement of the clamp arms from the open position to the closed position brings the set of drive wheels into engagement with the interchangeable tool holder.

11. The print head assembly of claim 10, wherein the at least one clamping actuator is a dual-threaded clamping screw.

12. The print head assembly of claim 10, wherein the set of drive wheels are positioned to engage with access slots on the interchangeable tool holder to advance a filament feedstock.

13. The print head assembly of claim 10, wherein the set of drive wheels engage a control switch on the interchangeable tool holder to actuate a non-feedstock tool.

14. The print head assembly of claim 10, further comprising a hotend assembly positioned to thermally engage a nozzle assembly of the interchangeable tool holder when the interchangeable tool holder is in a clamped position.

15. The print head assembly of claim 10, wherein the main body further comprises a mechanical latch attachment point for removably coupling to a tool changer carriage.

16. A method for automatically changing a tool in an additive manufacturing machine having a print head, a docking system, and a tool changer carriage, the method comprising:
retrieving a first interchangeable tool holder from a tool dock in the docking system with the tool changer carriage;
transporting the first interchangeable tool holder from the tool dock to the print head with the tool changer carriage;
loading the first interchangeable tool holder into a receptacle of the print head;
actuating a clamping mechanism of the print head to secure the first interchangeable tool holder, wherein actuating the clamping mechanism to secure the tool holder mechanically disengages the tool changer carriage from the print head;
operating a tool associated with the first interchangeable tool holder;
actuating the clamping mechanism to release the first interchangeable tool holder, wherein actuating the clamping mechanism to release the tool holder mechanically re-engages the tool changer carriage with the print head; and
storing the first interchangeable tool holder in the tool dock with the tool changer carriage.

17. The method of claim 16, wherein the step of actuating the clamping mechanism to secure the tool holder comprises moving the print head to a predefined position to engage a tool changing transmission, thereby redirecting motor power to the clamping mechanism.

18. The method of claim 17, wherein the engagement of the tool changing transmission causes a toggle switch to redirect a motor control signal from a tool change motor to an extruder motor of the print head, and wherein a subsequent re-engagement of the tool changing transmission to release the tool holder causes the toggle switch to redirect the motor control signal from the extruder motor back to the tool change motor.

19. The method of claim 16, wherein retrieving the first interchangeable tool holder comprises:
extending a gripper from the tool changer carriage to grasp the first interchangeable tool holder;
lifting the first interchangeable tool holder from the tool dock;
retracting the first interchangeable tool holder into a rotary carousel of the tool changer carriage; and
rotating the rotary carousel to orient the first interchangeable tool holder toward the print head.

20. The method of claim 16, further comprising, after the step of storing the first interchangeable tool holder:
retrieving a second interchangeable tool holder from a second tool dock in the docking system with the tool changer carriage;
loading the second interchangeable tool holder into the receptacle of the print head;
actuating the clamping mechanism to secure the second interchangeable tool holder; and
operating a tool associated with the second interchangeable tool holder.
